(19) United States
(12) Patent Application Publication
(10) Pub. No.: US 2026/0040171 A1
(43) Pub. Date: Feb. 5, 2026

(54) NTN-TN IDLE MODE MOBILITY FOR NW ENERGY SAVINGS

(71) Applicant: InterDigital Patent Holdings, Inc., Wilmington, DE (US)

(72) Inventors: Umer Salim, Vallauris (FR); Dylan Watts, Montreal (CA); Faris Alfarhan, Montreal (CA); Moon-il Lee, Melville, NY (US); Brian Martin, Farnham (GB); Paul Marinier, Brossard (CA); Oumer Teyeb, Montreal (CA); Keiichi Kubota, Tokyo (JP); Tao Deng, New York, NY (US); Jaya Rao, Montreal (CA); Ananth Kini, Conshohocken, PA (US)

(73) Assignee: InterDigital Patent Holdings, Inc., Wilmington, DE (US)

(21) Appl. No.: 18/794,993

(22) Filed: Aug. 5, 2024

(51) Int. Cl. H04W 36/08; H04W 36/00; H04W 84/06

(52) U.S. Cl. CPC H04W 36/083; H04W 36/0085; H04W 84/06

(57) ABSTRACT

Systems, methods, and instrumentalities are configured for NTN-TN idle mode mobility for network energy savings. A WTRU may receive configuration information for a first and second candidate NTN cell, each associated with different orbit types and power sharing statuses. The WTRU may receive a message to perform suitability determinations for these cells, conduct measurements, and determine if the first cell satisfies suitability conditions based on its power sharing status, orbit type, and measurement. Additionally, the WTRU may receive a second message from a TN cell indicating a shutdown, prompting the exclusion of these TN cells from re-selection.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein that may be associated with NTN-TN mobility (e.g., NTN-TN idle mode mobility). A wireless transmit receive unit (WTRU) may include a processor and the WTRU may perform or may be configured to perform one or more of the following.

A wireless transmit receive unit (WTRU) may receive configuration information associated with non-terrestrial network (NTN) cells. The configuration information may indicate a first candidate NTN cell and a second candidate NTN cell. The first candidate NTN cell may be associated with a first orbit type and a first NTN power sharing status. The second candidate NTN cell may be associated with a second cell orbit type and a second NTN power sharing status. The WTRU may receive a first message that indicates to perform an NTN cell suitability determination associated with the first candidate NTN cell and the second candidate NTN cell. The WTRU may perform a measurement associated with the first candidate NTN cell and a measurement associated with the second candidate NTN cell. The WTRU may determine that the first candidate NTN cell satisfies suitability conditions based on the first NTN power sharing status, the first orbit type, and the measurement associated with the first candidate NTN cell. Satisfaction of the suitability conditions may include satisfaction of one or more of: an NTN power sharing status condition, an orbit condition, and a measurement threshold condition. The WTRU may receive a second message, and the second message may be received from a terrestrial network (TN) cell, and the second message may indicate a shutdown associated with a first one or more TN cells. The WTRU may exclude the first one or more TN cells associated with the shutdown as re-selection candidates based on the received second message.

The WTRU may determine that the first candidate NTN cell will become unavailable based on one or more of satisfying an NTN power sharing condition, satisfying a service coverage condition, or an indication from the first candidate NTN cell. The WTRU may receive an indication of a wake up signal configuration. The wake up signal configuration may indicate a second one or more TN cells, and the wake up signal configuration may indicate cell re-selection conditions based on a timer or a WTRU location.

The WTRU may transmit a wake up signal to a TN cell from the second one or more TN cells for which the cell re-selection conditions are satisfied, and the wake up signal may be configured according to the wake up signal configuration. The WTRU may detect a wake up of a TN cell from the second one or more TN cells based on a signal received from the TN cell from the second one or more TN cells. The WTRU may perform reselection to the TN cell from the second one or more TN cells for which the cell re-selection conditions are satisfied.

The cell re-selection conditions may include one or more of a time validity associated with the wake up signal configuration, a location validity associated with the wake up signal configuration, a location validity associated with cell coverage, or a location validity associated with a location of the WTRU.

The NTN power sharing condition may include one or more of a discontinuous transmission period that exceeds a time threshold, a ratio of inactive duration to active duration exceeding a ratio threshold, or a power sharing of beams with a power reduction. The power reduction may exceed a power threshold. The WTRU may perform cell re-selection to the first candidate NTN cell. The WTRU may receive configuration information associated with a second one or more TN cells. The WTRU may evaluate the second one or more TN cells and the first candidate NTN cell for re-selection. The WTRU may perform reselection on the first candidate NTN cell or one of the second one or more TN cells.

The WTRU may determine to perform and/or perform the measurement associated with the first candidate NTN cell based on one or more of: the first NTN power sharing status, the first orbit type, a power status of the WTRU, or a mobility estimate associated with the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of an NTN cell overlap with TN cells associated with WTRUs per TN cell.

### DETAILED DESCRIPTION

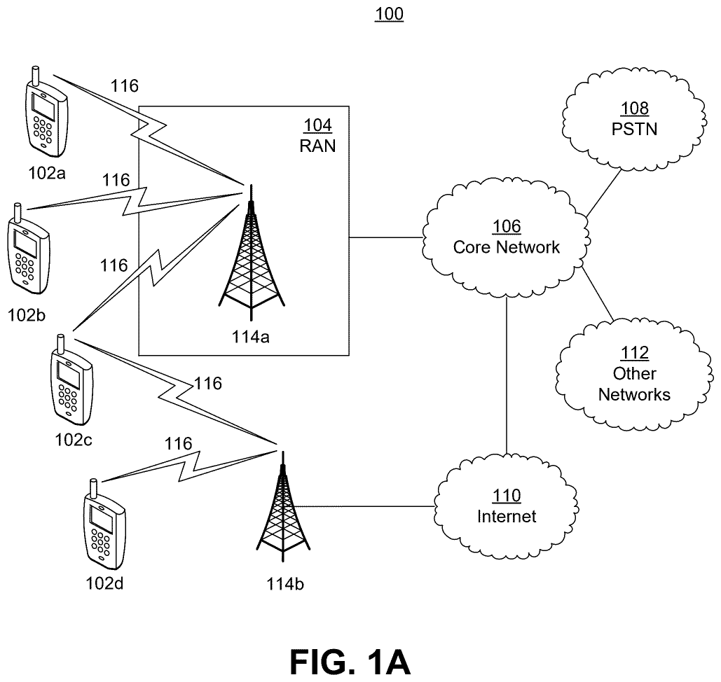

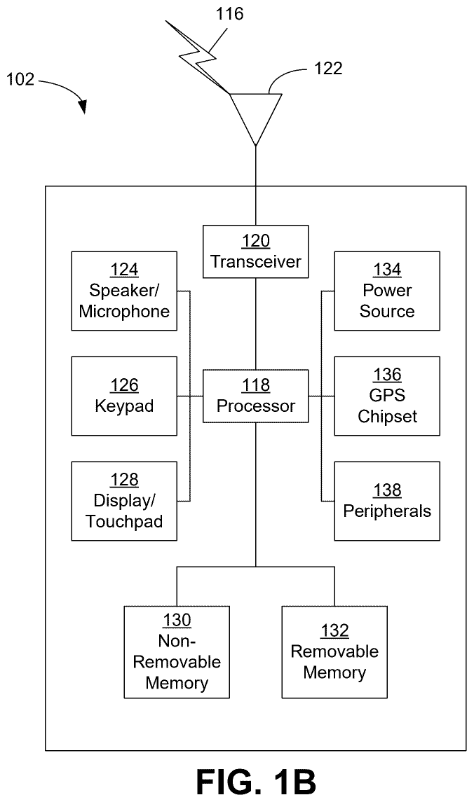

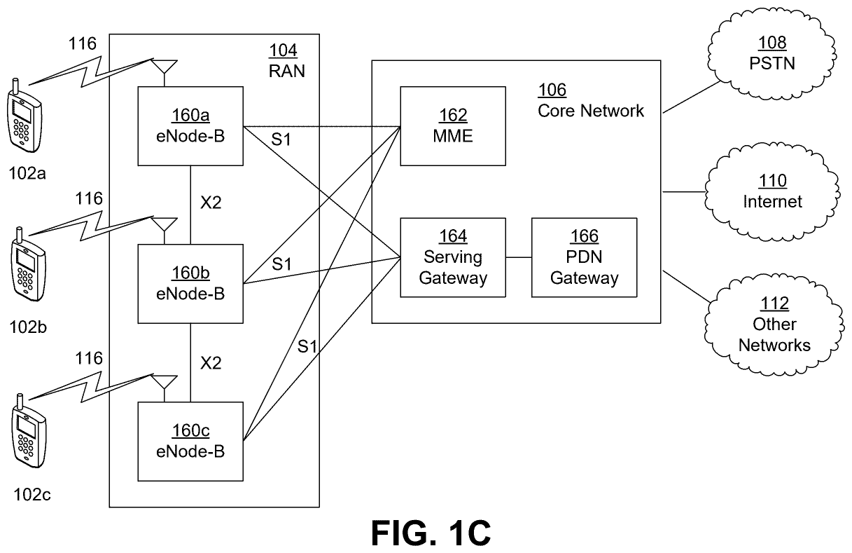

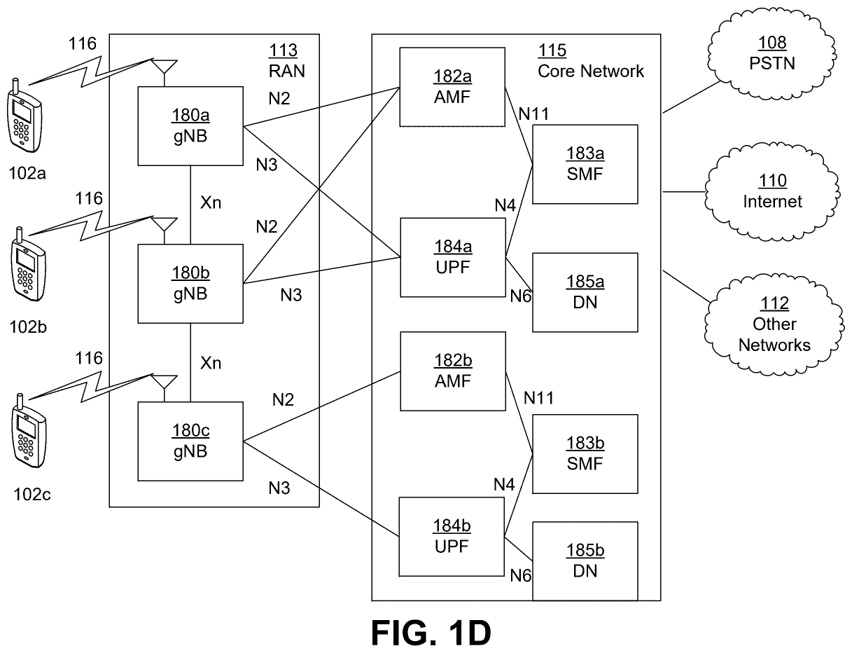

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data. A WTRU camped over a TN cell may detect a first indication to validate if an NTN cell is suitable. The WTRU may make measurements over the indicated NTN cell and evaluate the measurements if the measurements fulfill the configured conditions. The WTRU may detect a second indication whereby a TN cell indicates its shut-down. Upon detecting the second indication, the WTRU may exclude TN cell(s) from re-selection candidates and re-select to an NTN cell.

A WTRU, camped over an NTN cell, may receive/detect the indication of NTN cell becoming not available/suitable (NTN power sharing/link conditions). The WTRU may receive assistance information from the NTN cell about the neighboring TN cells. The WTRU may detect/determine a suitable TN cell and wake up the SLEEPING TN cell to camp on.

A WTRU may be camped on a TN cell and configured with one or more of the following: a configuration for NTN cells to perform measurements in IDLE/INACTIVE mode. The WTRU may receive characteristics of the NTN cells (e.g., LEO, MEO, GEO), power sharing status and SIBs (e.g., SIB19); a first message configuration to validate that at least one of the NTN cells is suitable; and a second message configuration indicating TN cell shutting down.

The WTRU may detect/receive a first message indicating to validate that at least one of the NTN cells is suitable, where the first message may be an explicit indication (e.g., paging message, or SI update message or downlink (DL)-WUS (DL-WUS), freq priority update indication SIB), or an implicit indication (e.g., reduced/modified/SIB1-less SSB, etc.).

The WTRU (e.g., power saving WTRU) may select NTN cells to perform measurements based on one or more of the following: NTN Beam power sharing status (e.g., if provided by TN cell); cells of a specific orbit (e.g., WTRU may select GEO cells to avoid frequent re-selections and SI maintenance); WTRU power status (e.g., if WTRU is a plugged device, CPE); or WTRU local mobility estimate (e.g., fixed or static vs WTRU in mobility).

The WTRU may determine the selected/indicated NTN cells being suitable based on the following conditions: NTN Beam power sharing status e.g., received from TN/NTN or detected from signals, inactive Periodicity less than T, active beam power reduction less than P, cells of a specific orbit (e.g., WTRU may select GEO cells to avoid frequent re-selections and SI maintenance); RSRP of the RS (e.g., SSB) is better than a threshold (e.g., with/without compensated measurements if NTN cells under Beam power sharing); or no suitable cell.

The WTRU may detect/receive a second message from TN cell indicating a shut-down of TN cells (e.g., single TN cell, RNA/TAC cells, etc.) after a threshold duration, where the second message may be an explicit indication (e.g., paging or SI update message or DL-WUS, freq priority update indication SIB) or an implicit indication (e.g., reduced/modified/SIB1-less SSB etc.). The type of second message may be based on the type of the first message.

The WTRU may exclude the TN cells (e.g., camped cell or the intra-freq or same RNA/TAC, or all TN) as candidate(s) for cell selection/reselection for a configured duration T (e.g., 300 seconds). The WTRU may camp over the NTN cell (e.g., as a by-product of previous exclusion step of TN cells).

The WTRU may transmit the stay awake indication to the TN cell based on determining that there is no suitable NTN cell, where the stay awake indication may be one or more of the following: transmitted over a common/shared resource (e.g., cell specific resource); or based on random access channel (RACH)/UL-WUS/SRS transmission

A WTRU is camped on an NTN cell and configured with the following: a configuration for (e.g., sleeping) TN cells where the configuration may provide any of the following.

The configuration may provide timing, frequency, cell identity in suitable format. The configuration may provide energy saving state of the cell (e.g., cell DTx with associated parameters, SSB cell (e.g., SSB only cell) with on-demand SIB1 configuration, modified SSB transmitting cell, cell in deep sleep with no transmission at all).

The configuration may provide a coverage indication for a cell where the coverage indication can be provided. In an example, the coverage indication may be a reference location with a radius indication. The reference location may be the (virtual) cell center of the target cell, or it may be the TRP location, or it may be a suitable boundary point b/w NTN and TN cell boundary. In examples, the coverage indication can be with respect to a different shape, a rectangle, a polygon etc.

The configuration may provide a UL-WUS configuration to a wake-up TN cell with validity conditions.

The WTRU may determine an NTN cell becoming unavailable in the future due to NTN Power Sharing (e.g., DTx period larger than T, power-sharing larger than P) or T_Service (e.g., WTRU losing service coverage). The WTRU determination of an NTN cell becoming unavailable may be based on one or more of the following: an explicit indication received from the NTN cell (e.g., broadcast of information, system information update in any SIB, e.g., SIB1, SIB19 etc., paging, etc.); an implicit indication through detecting change in one of the broadcast signals, e.g., change of SSB periodicity, change of SSB structure (to slim SSB e.g.,), change in SIB transmission (e.g., missing SIB1).

The WTRU may receive assistance information from the NTN cell related to the neighboring TN cells. The information may be the same/similar as provided by NTN cell as described herein and/or complement or override the configuration stored at the WTRU

The WTRU may determine the TN cell configurations based on received coverage indications and its own location. For example, the WTRU may select the TN cells based on determination that its determined location lies inside the indicated coverage of that cell. In examples, the WTRU may select the cell whose reference point is closest to its determined location. The WTRU may select one or more cells based on indicated coverage and its own location determination.

The WTRU may select one or more cells based on detected SSBs (or modified SSBs). The WTRU may detect SSBs based on received configurations for TN cells indicating time, frequency and other parameters for the TN cells.

The WTRU may transmit an UL-WUS to the selected (sleeping) TN cell according to the received WUS configuration if one or more of the following conditions are satisfied: time validity for UL-WUS configurations are valid (e.g., config timer has not expired); location validity for the cell coverage; location validity for UL-WUS configuration is valid (e.g. WTRU distance from a Ref Location); number of re-transmissions according to the UL-WUS config; SSBs (legacy/slim/modified) detected for the cell are received with sufficient received power levels (e.g., RSPR higher than a configured threshold)

The WTRU may detect SSBs (and SIBs, e.g., SIB1) from the TN cell within a threshold duration after its transmission of UL-WUS signal.

The WTRU may perform re-selection to the TN cell if the cell re-selection criteria is satisfied (e.g., the TN cell is a suitable cell for camping purpose).

The WTRU may determine an NTN cell becoming not suitable (e.g., RSRP of the SSBs from NTN cell falls below a configured threshold, RACH failure on NTN cell). The WTRU determination of NTN cell becoming unavailable may be based on one or more of the following: RSRP of the SSBs from NTN cell falls below a configured threshold; or RACH failure on NTN cell

Features described herein may be associated with non-terrestrial networks (NTNs). An NTN may include an aerial or space-borne platform which, via a gateway (GW), transports signals from a land-based based gNB to a WTRU and vice-versa. Aerial or space-borne platforms may be classified in terms of orbit, with non-geosynchronous orbit (NGSO) satellites including low-earth orbit (LEO) with altitude range of 300-1500 km and medium-earth orbit (MEO) satellites with altitude range 7000-25000 km. NGSO satellites may move continuously overhead relative to earth, and Geosynchronous orbit (GSO) satellites may remain fixed overhead by maintaining an altitude at 35 786 km.

Satellite platforms may be further classified as having a transparent or regenerative payload. Transparent satellite payloads may implement frequency conversion and radio frequency (RF) amplification in both uplink and downlink, with multiple transparent satellites possibly connected to one land-based gNB. Regenerative satellite payloads may implement either a full gNB or gNB DU onboard the satellite. Regenerative payloads may perform digital processing on the signal including demodulation, decoding, re-encoding, re-modulation and/or filtering.

An NTN satellite may support multiple cells, where a cell may include one or more satellite beams. Satellite beams may cover a footprint on earth (like a terrestrial cell) and may range in diameter from 100-1000 km in NGSO deployments, and 200-3500 km diameter in GSO deployments. Beam footprints in GSO deployments may remain fixed relative to earth, and in NGSO deployments the area covered by a beam/cell changes over time due to satellite movement. The beam movement may be classified as earth moving where the NGSO beam moves continuously across the earth, or earth fixed where the beam is steered to remain covering a fixed location until a new cell overtakes the coverage area in a discrete and coordinated change.

Non-terrestrial networks may be associated with continuous movement of NGSO satellites overhead resulting in frequent and continuous cell change; cell sizes up to 3500 km in diameter; and round trip times (RTT) several orders of magnitude larger than terrestrial networks (e.g., up to 541.46 ms)

Features described herein may be associated with network energy savings (NES). A network may minimize its power consumption from transmission and reception. Such minimization may be associated with reducing operational costs and environmental sustainability.

Minimizing transmissions from the network based on there being no data may be associated with efficiency. For example, always-on cell-specific reference signal (CRS) may not be used. Energy consumption reduction may be possible.

For example, the network may consume energy based on no transmission from other activities such as baseband (digital) processing for reception or beamforming. Such idle power consumption may not be negligible in dense networks based on no WTRU being served during a given period. If the network could turn off these activities based on not transmitting to a WTRU, energy consumption may be reduced.

Transmission of always-on synch or reference signals may not be (e.g., required) adaptable bandwidth, and multiple input multiple output (MIMO) capabilities may be supported. Adaptation of network resources may enable greater efficiency in operating newer deployments and later generations.

The following may be used herein. Channel state information (CSI) may include at least one of the following: channel quality index (CQI), rank indicator (RI), precoding matrix index (PMI), an L1 channel measurement (e.g., RSRP such as L1-RSRP, or SINR), CSI-RS resource indicator (CRI), SS/PBCH block resource indicator (SSBRI), layer indicator (LI) and/or any other measurement quantity measured by the WTRU from the configured CSI-RS or SS/PBCH block.

Uplink control information (UCI) may include: CSI, hybrid automatic repeat request (HARQ) feedback for one or more HARQ processes, Scheduling request (SR), Link recovery request (LRR), configured grant (CG)-UCI (CG-UCI) and/or other control information bits that may be transmitted on the PUCCH or PUSCH.

Channel conditions may be conditions relating to the state of the radio/channel, which may be determined by the WTRU from: a WTRU measurement (e.g., L1/SINR/RSRP, CQI/modulation and coding scheme (MCS), channel occupancy, RSSI, power headroom, exposure headroom), L3/mobility-based measurements (e.g., RSRP, RSRQ, s-measure), an radio link monitoring (RLM) state, and/or channel availability in unlicensed spectrum (e.g., whether the channel is occupied based on determination of an listen-before-talk (LBT) procedure or whether the channel is deemed to have experienced a consistent LBT failure) or measurements described herein.

A physical random access channel (PRACH) resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random access procedure.

A property of scheduling information (e.g., an uplink grant or a downlink assignment) may consist of at least one of the following: a frequency allocation; an aspect of time allocation, such as a duration; a priority; a modulation and coding scheme; a transport block size; a number of spatial layers; a number of transport blocks to be carried; a TCI state or SRI; a number of repetitions; whether the grant is a configured grant type 1, type 2 or a dynamic grant.

An indication by downlink control information (DCI), or an indication, may include at least one of the following: an explicit indication by a DCI field or by radio network identifier (RNTI) used to mask cyclic redundancy check CRC of the PDCCH. An implicit indication by a property such as DCI format, DCI size, Coreset or search space, aggregation level, identity of first control channel resource (e.g., index of first control channel element CCE) for a DCI, where the mapping between the property and the value may be signaled by RRC or MAC. An explicit indication by a DL MAC control element (CE).

The terms network availability state, cell turned off, cell DTX mode/configuration, or NES state may be used interchangeably. The WTRU may determine a cell DTX/DRX state implicitly from a determined active availability state, and visa-versa.

The WTRU may determine whether it can transmit or receive on certain resources depending on a network availability state, which implies the gNB's power savings status. An availability state may correspond to a network energy savings state, a cell DTX mode, a cell DRX mode, and/or a gNB activity level. An availability state may be uplink or downlink specific, and may change from symbol to symbol, slot to slot, frame to frame, or on longer duration granularity. The availability state may be determined by the WTRU or indicated by the network. An availability state may be, for example, on, DL and UL active, UL active (e.g., UL only active), off, reduced Tx power, dormant, micro sleep, light sleep, or deep sleep. Such states may be abstracted by NW configuration parameters and/or values, and dynamic indication may point to the active availability state (e.g., by DCI or MAC CE signaling). The off availability state may imply that the gNB's baseband hardware is completely turned off. The sleep availability state may imply that the gNB wakes up periodically to transmit certain signals (e.g., presence signals, synchronization, or reference signals) or receive certain UL signals. In availability states, DL or UL resources may not be available during certain periods of time, which may enable the network to turn off baseband processing and other activities. For example, the WTRU may be configured by RRC with periodic active and inactive periods per availability. Measurement resources (e.g., SSBs or CSI-RS) may be made available in certain availability states, including: RLM, BFD, RRM measurements, CSI-RS feedback configuration, and/or a different power offset for CSI feedback [6, 7].

Under certain conditions, the WTRU may further transmit a request to the network (e.g., wake-up request) to modify the availability state to a state for which resources that would satisfy WTRU parameters (e.g., requirements) are available.

The WTRU may determine an availability state from reception of availability state indication from e.g., by L1/L2 signaling (e.g., a group common DCI or indication), or implicitly determine it form the reception of periodic DL signaling-or lack thereof.

The WTRU may determine if a resource is available for transmission/reception and/or measurements for the determined network availability state if it is applicable in the active availability state. The WTRU may also adapt its active C-DRX cycle, active spatial elements (e.g., antenna or logical ports), active TRPs, paging occasions as a function of the signaled or determined availability state. The WTRU may be configured with one or more sets of NES transmission and/or reception parameters per availability state, e.g., by broadcast or dedicated configuration signaling. The WTRU may apply the NES parameter set according to the determined or signaled availability state. The WTRU may apply one or more applicable configurations depending on the determined NES state. A set of NES parameter may include: a number of antenna ports, a C-DRX configuration, a measurement configuration (e.g., for RRM, RLM, and/or BFD), CSI feedback, a CSI-RS configuration, an SSB configuration, CHO or mobility candidates, a set of active TRPs.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part. For example, based on an NES state changing in a cell, the WTRU may receive an availability state change indication indicating that the change is for the cell, for (e.g., all) cells at the same frequency, or/and same RAT.

The WTRU may consider the active availability state associated with a cell, carrier, TRP, or frequency band to be off, deep sleep, or micro sleep after reception of a DL signaling that changes the cell's or TRP's availability state. For example, the WTRU may receive a turn off command on broadcast signaling, RRC signaling, DCI (e.g., a group common DCI), or a DL MAC CE (e.g., indication part of PDSCH). The WTRU may determine an availability state from reception of availability state indication from e.g., by L1/L2 signaling (e.g., a group common DCI or indication) or broadcast signaling associated with an availability state.

In examples, an availability state change indication may be part of an SI update or SIB signaling (e.g., in a separate SIB that is not read by other WTRUs (e.g., legacy WTRUs). There may be a common time for WTRUs in the cell to determine availability state status.

The WTRU may determine a change of NES state change from the reception of a group common command L1 signaling (e.g., a group common DCI, a multi-stage DCI, a specific DCI format, or a DCI scrambled by a configured or specified NES-specific RNTI). L1 signaling may indicate one of the configured NES parameters sets to apply or may determine a delta configuration from the current set of parameters based on determining an NES state change. The WTRU may transmit feedback/acknowledgment to gNB, possibly multiplexed with UL data (e.g., part of an UL TB as a MAC CE or a sub header indication), following the reception of NES state change indication.

The WTRU may determine a change of NES state change from the reception of broadcast signaling associated with NES state indication or change, including signaling in SIB(s) or part of a broadcast or multicast PDSCH. The WTRU may be indicated the NES state explicitly in the SIB. The WTRU may be configured with one or more SIBs exclusively associated with configuration of NES parameters. The WTRU may be configured to receive such broadcast or multicast indication periodically. The WTRU may determine an indication is mis-detected if not received on expected periodic occasions, if a number of misdetections is counted, and/or if a timer has elapsed since the last reception of the NES state indication. The WTRU may start inter-cell, inter-frequency, and/or inter-RAT measurements, start a mobility procedure, and/or start evaluating configured CHO candidates following the determination of a misdetection of the NES state indication.

The WTRU may implicitly assume a certain availability state associated with a cell, carrier, TRP, or frequency band (e.g., off, deep sleep, micro sleep or dormant) from at least one of the following: The WTRU may implicitly assume a certain availability state associated with a cell, carrier, TRP, or frequency band (e.g., off, deep sleep, micro sleep or dormant) from reception of a command or signal indicating a change in availability state: e.g., a group common DCI in connected mode or RRC signaling or a presence signal. The WTRU may determine an availability state implicitly form the reception of periodic DL signaling. The WTRU may be configured or specified to associate an availability state with one or more DL signal type (e.g., SSB, partial SSB, and/or one or more periodicity).

The WTRU may implicitly assume a certain availability state associated with a cell, carrier, TRP, or frequency band (e.g., off, deep sleep, micro sleep or dormant) from reception of a paging message, paging DCI, paging PDSCH, or a paging related signal (e.g., PEI), possibly on a subset of paging occasion (Pos) (e.g., those aligned with NES DRX cycle or a configured subset of PDCCH resources). The WTRU may assume a availability state after reception of an indication part of the DCI or PDCCH scheduling paging (e.g., as a function of the P-RNTI, NES-RNTI or based on receiving an explicit indication, e.g., on a reserved bit). The WTRU may assume an availability state after the reception of a paging message with a P-RNTI, a separately configured NES P-RNTI, or the NES group RNTI. The WTRU may assume an availability state after the reception of a paging message with a certain P-RNTI. The WTRU may be configured with one more PEI subgroup for NES, where a subgroup may be associated with one or more availability states.

The WTRU may assume an availability state after reception of a PEI with an NES subgroup, for example, if the subgroup is configured and/or associated with the availability state. The indication of the availability state or the availability state switch may be indicated in the paging payload, e.g., as a flag part of the paging message or the short message. Such paging indication may further indicate an alternative cell to monitor paging on while the cell from which the signaling was received is off, sleep, or in NES state. Such paging indication may further indicate or signal applicable reconfiguration parameters (e.g., for initial access, applicable PRACH resources, applicable SSB/RS occasions, applicable SI cycle, and/or the applicable cell(s) and associated availability states).

The WTRU may implicitly assume a certain availability state associated with a cell, carrier, TRP, or frequency band (e.g., off, deep sleep, micro sleep or dormant) from the gNB DTX status (e.g., whether the gNB is in active time or an associated activity timer is running).

The WTRU may implicitly assume a certain availability state associated with a cell, carrier, TRP, or frequency band (e.g., off, deep sleep, micro sleep or dormant) from lack of detection of a presence indication.

The WTRU may determine an availability state associated with the cell (e.g., off or deep sleep) if presence indication was not detected on one or more presence indication occasion.

The WTRU may assume or change the cell's availability state after a number of consecutive misdetections or after timer expires following no detection of a presence signal. The WTRU may determine an availability state is active or de-active after expiry of a timer associated with the availability state. Such timer can be configured and/or maintained in connected mode or in other states (e.g., idle and inactive states).

The WTRU may determine an availability state implicitly from the lack of reception of periodic DL signaling. For example, the WTRU may be configured with a signal quality threshold (e.g., an RSRP threshold), and if the WTRU does not detect a signal associated with an availability state (e.g., a presence signal or an SSB) with a signal strength above the threshold, the WTRU may assume that the availability state is not active and may assume a different availability state. The criterion may be coupled with lack of detection of an identifying sequence of the presence signal (e.g., detection of the primary synchronization signal (PSS) sequence, for example).

The WTRU may determine an availability state based on time in the day. The WTRU may be configured to automatically assume a certain availability state (e.g., off, sleep, or dormant) for a configured subset of cells (e.g., capacity boosting cells) depending on time in the day. For example, the WTRU may determine that a capacity boosting cell has an availability state as on in certain hours of the day, deep sleep in other configured hours, and off in a third set of configured hours of the day or night.

The WTRU may determine an availability state based on the availability state of an associated cell (e.g., another carrier of the same MAC entity, another carrier in the same cell group, another carrier in the same gNB, another sector in the same gNB, or a configured associated cell or capacity boosting cell).

The WTRU may determine an availability state from any of the following: detection of a PSS signal (e.g., PSS only signal) or a simplified/stripped down SSB signal; detection of an RS signal (e.g., CSI-RS, PRS, TRS) or the lack thereof; the WTRU's RRC state (Idle, inactive, or connected mode); whether paging has been received, possibly within a configured time window; and/or whether system information (e.g., periodic SI or a subset of SIBs) have been received, possibly within a configured time window.

The WTRU may determine an availability state from measured channel condition(s) being below or above a threshold. The WTRU may assume a change of NES state based on a change of measured channel conditions or making a channel measurement below or above a threshold. For example, the WTRU may use degradation in measurements of SSBs or CSI-RS (e.g., in combination with other signaling) to determine the NES state. For example, a configured window following the DCI reception may be used to measure SSBs and/or CSI-RS for degradation, and if a delta of SSB-RSRP drop is measured, the WTRU may determine that the NES state has changed and assume associated actions for such NES state (e.g., trigger for CHO candidate selection or for group scheduling for a mobility command).

The WTRU may be configured to monitor an indication that may characterize the level of network activity (e.g., an availability state). The network activity may be associated with a gNB and/or a cell. The WTRU may assume the same availability state for all cells part of the same gNB, e.g., cells of the same MAC entity. The network activity indication (e.g., the presence indication) may include a channel (e.g., a PDCCH) and/or a signal (e.g., a sequence). The activity indication or the NES state change indication/command may indicate the level of activity the WTRU may expect from the associated gNB and/or cell, e.g., reduced activity. The activity indication may include activity information of other gNBs/cells. The activity indication may be a PDCCH including group common signaling. For example, the NW may transmit a group common DCI to a group of WTRUs (e.g., WTRUs in the serving cell) indicating a change of an activity state or activity level in UL and/or DL. The CRC of the PDCCH may be scrambled with a dedicated activity indication RNTI or an NES-RNTI. A WTRU may be configured with at least one search space associated with the monitoring occasions of the activity indication PDCCH. The indication may include a go-to-sleep signal, e.g., a predefined sequence. When the WTRU detects the sequence, the WTRU may expect a reduced activity level over a specific time duration. The WTRU may activate C-DRX for the period of time indicated. Two sequences may be used to indicate regular activity and reduced activity.

The signaling within the PDCCH or the activity indication may include at least one of the following. The signaling within the PDCCH or the activity indication may include an expected activity level of the associated gNBs/cells over a specific time interval (e.g., an availability state). The activity levels may be predetermined and/or configured and may, for example, include regular and reduced activity. The signaling may indicate the activity level. For example, bit 1 may indicate regular activity and bit 0 may indicate reduced activity.

The signaling within the PDCCH or the activity indication may include, for an activity level (e.g., availability state), transmission and reception attributes, which may be defined. For example, during reduced activity, WTRU may not be expected to monitor certain PDCCH search spaces (including all SSs), and/or receive a certain type of PDSCH (including all PDSCH), and/or transmit PUCCH/PUSCH, and/or perform certain measurements. The WTRU may start or stop monitoring PDCCH and/or TCI states associated with determined NES state, including PDCCH resources or TCI states associated with (de) activated TRPs or spatial elements.

The signaling within the PDCCH or the activity indication may include a set of configurations, which may be associated with an activity level and may be used/applied based on the activity level being indicated (e.g., an NES parameter set) (e.g., SS configurations, CSI reporting configurations, indices of transmitted SSBs, etc.). A set of configurations may have an attribute associated with an activity level (e.g., a tag that can be set to reduced activity).

The signaling within the PDCCH or the activity indication may include the time interval over which an activity level is assumed may be signaled in the PDCCH or part of the activity indication. The time interval may be indicated using a bitmap where a bit in the bitmap may be associated with a specific duration, e.g., a slot or a frame. For example, bit 1 may indicate regular activity and bit 0 may indicate reduced activity on an associated frame.

The time interval may be indicated with a start time and length of interval. The start time may be defined; for example, the start time may be determined by adding a fixed offset to the time the indication is received. The length of the interval may be configured or signaled in the indication PDCCH.

The signaling within the PDCCH or the activity indication may include the time interval over which an activity level is assumed may be predetermined. The WTRU may assume an interruption delay (or more generally, a time until the NES state changes) after the NES state change command reception (e.g., after the last symbol or slot on which the command was received). The interruption time may be in absolute time, a number of symbols, or a number of slots.

The WTRU may determine that an uplink or downlink resource or signal is available for transmission/reception and/or measurements for the determined network availability state if it is applicable in the active availability state. The WTRU may determine that a subset of measurement resources and/or signals (e.g., SSBs, CSI-RS, TRS, PRS) are not applicable in certain availability states. The WTRU may determine that a subset of uplink or downlink resources (e.g., PRACH, PUSCH, PUCCH) are not applicable in certain availability states. The WTRU may transmit some uplink signals in a subset of NW availability states (e.g., SRS, pSRS, PRACH, UCI).

Features described herein may be associated with an NES alternative cell. The WTRU may perform cell (re)-selection, mobility to another serving cell, trigger mobility related measurements, and/or start evaluating CHO candidates on alternate cells based on determining an NES change on the camped cell or the serving cell. The WTRU may be configured or predefined with an alternative serving cell to perform initial access, mobility, or cell reselection on in the event the current serving cell or a capacity boosting cell (e.g., a cell not configured as an alternative cell) is turned off or a certain condition is met. The WTRU may be configured per broadcast or dedicated signaling with a list of fallback or alternative serving cells, possible per serving cell, per gNB, per PLMN, or per network identity.

In examples, the WTRU may initiate a cell reselection or mobility procedure to an alternative serving cell associated with a cell or gNB from which a turn-off indication was received. In examples, the turn off or go-to-sleep indication may dynamically indicate to the WTRU which cell to fallback or connect to, e.g., by dedicated or broadcast signaling. The fallback/alternative cell may be configured or predefined to be a cell within the same gNB from which a sector has entered NES state (e.g., off, sleep, or reduced power). In examples, the fallback cell may be predefined as the master node cell if the WTRU is in dual connectivity. The fallback/alternative cell may be configured or predefined to be a cell associated with a different RAT or frequency band. For example, the WTRU may fallback to an LTE or an FR1 cell associated with the cell or gNB from which the turn off indication was received (e.g., if the WTRU is in CA or DC using multiple RATs or multiple frequency bands).

The terms alternative cell and stable cell may be used interchangeably herein. The WTRU may be configured with a list of stable cells (e.g., alternative cells that will not turn off, e.g., macro cells). The list may be a list of alternative cells per serving/camped cell or a general list of PCIs for the whole NW, tracking area, etc. The WTRU may be configured with measurement object configuration for the alternative cells. Alternative cells may be preconfigured to be CHO candidates (e.g., considered as CHO candidates if the source cell turns off/activates NES).

Features described herein may be associated with mobility in RRC_IDLE/RRC_INACTIVE mode. Features described herein may be associated with cells selection. The WTRU may search the NR frequency bands and, for a carrier frequency, identify the strongest cell based on the cell defining SSB (CD-SSB). The frequency bands and carriers may be transmitted by terrestrial base stations or non-terrestrial base stations. The WTRU may read a cell system information broadcast to identify its PLMN(s) to find a suitable cell to camp on. A suitable cell may be a cell for which the measured cell attributes satisfy the cell selection criteria; the cell PLMN may be the selected PLMN, registered or an equivalent PLMN; the cell may not be barred or reserved, and the cell may not be part of a tracking area which is in the list of forbidden tracking areas for roaming.

On transition from RRC_CONNECTED to RRC_INACTIVE or RRC_IDLE, a WTRU may camp on a cell as a result of cell selection according to the frequency to be assigned by RRC in the state transition message (e.g., if any).

The cell selection criterion (e.g., criterion S) may be fulfilled where:

$$Srxlev > 0 AND Squal > 0$$

where:

$$Srxlev = Qrxlevmeas - ( Qrxlevmin + Qrxlevminoffset ) - Pcompensation - Qoffsettemp$$

$$Squal = Qqualmeas - ( Qqualmin + Qqualminoffset ) - Qoffsettemp$$

where the following may be applicable, as noted in Table 1:

TABLE 1

| | |
|---|---|
| Srxlev | cell selection RX level value (dB) |
| Squal | cell selection quality value (dB) |
| Qoffsettemp | Offset temporarily applied to a cell as specified in TS 38.331 (dB) |
| Qrxlevmeas | Measured cell RX level value (RSRP) |
| Qqualmeas | Measured cell quality value (RSRQ) |
| Qrxlevmin | Minimum RX level in the cell (dBm). If the WTRU supports SUL frequency for |
| | the cell, Qrxlevmin may be obtained from q-RxLevMinSUL, if present, in |
| | SIB1, SIB2 and SIB4. Additionally, if QrxlevminoffsetcellSUL is present in |
| | SIB3 and SIB4 for the concerned cell, the cell specific offset may be added |
| | to the corresponding Qrxlevmin to achieve the minimum RX level in the |
| | concerned cell. Qrxlevmin may be obtained from q-RxLevMin in SIB1, SIB2 |
| | and SIB4, additionally, if Qrxlevminoffsetcell is present in SIB3 and SIB4 for |
| | the concerned cell. This cell specific offset may be added to the |
| | corresponding Qrxlevmin to achieve the minimum RX level in the concerned |
| | cell |
| Qqualmin | Minimum quality level in the cell (dB). Additionally, if Qqualminoffsetcell is |
| | signaled for the concerned cell, the cell specific offset may be added to |
| | achieve the minimum quality level in the concerned cell. |
| Qrxlevminoffset | Offset to the signaled Qrxlevmin taken into account in the Srxlev evaluation |
| | as a result of a periodic search for a higher priority PLMN while camped |
| | normally in a VPLMN. |
| Qqualminoffset | Offset to the signaled Qqualmin taken into account in the Squal evaluation |
| | as a result of a periodic search for a higher priority PLMN while camped |
| | normally in a VPLMN. |
| Pcompensation | For FR1, if the WTRU supports the additionalPmax in the NR-NS-PmaxList, |
| | if present, in SIB1, SIB2 and SIB4: |
| | max(PEMAX1 − PPowerClass, 0) − (min(PEMAX2, PPowerClass) − |
| | min(PEMAX1, PPowerClass)) (dB); |
| | else: max(PEMAX1 − PPowerClass, 0) (dB) |
| | For FR2, Pcompensation may be set to 0. |
| | For IAB-MT, Pcompensation may be set to 0. |
| PEMAX1, PEMAX2 | Maximum TX power level of a WTRU may use based on transmitting on the |
| | uplink in the cell (dBm) defined as PEMAX. If WTRU supports SUL |
| | frequency for the cell, PEMAX1 and PEMAX2 are obtained from the p-Max |
| | for SUL in SIB1 and NR-NS-PmaxList for SUL respectively in SIB1, SIB2 |
| | and SIB4 as specified, else PEMAX1 and PEMAX2 are obtained from the p- |
| | Max and NR-NS-PmaxList respectively in SIB1, SIB2 and SIB4 for normal |
| | UL. |
| PPowerClass | Maximum RF output power of the WTRU (dBm) according to the WTRU |
| | power class. |

The signaled values Qrxlevminoffset and Qqualminoffset may be applied based on a cell being evaluated for cell selection as a result of a periodic search for a higher priority PLMN while camped in a VPLMN. During the periodic search for higher priority PLMN, the WTRU may check the S criteria of a cell using parameter values stored from a different cell of the higher priority PLMN.

Features described herein may be associated with cell reselection. A WTRU in RRC_IDLE/RRC_INACTIVE may perform cell reselection. The WTRU may perform intra-frequency, inter-frequency or inter-RAT cell re-selection.

The WTRU may be configured with priorities among RATs (e.g., prioritize camping on NR over LTE based on an NR cell being available) or among frequencies within the same RAT (e.g., fa has highest priority, fb has medium priority, fc has lowest priority, etc.,). A neighbor cell list (NCL) may be provided to the WTRU, indicating which neighbor cells (e.g., intra-frequency, inter-frequency, inter-RAT) are to be considered for cell reselection. Allow-lists may be provided to the WTRU, indicating the neighboring cells that could be considered for re-selection. Exclude-lists may be provided to the WTRU, indicating the neighboring cells that should not be considered for re-selection.

The WTRU may try to camp on a cell operating with the highest priority RAT and with the highest priority frequency. If the serving cell fulfils Srxlev>SintraSearchP and Squal>SIntraSearchQ, the WTRU may choose not to perform intra-frequency measurements; otherwise, the WTRU shall perform intra-frequency measurements.

If the serving cell fulfils Srxlev>SnonIntraSearchP and Squal>SnonIntraSearchQ, the WTRU may choose not to perform measurements of NR inter-frequency cells of equal or lower priority, or inter-RAT frequency cells of lower priority;

The WTRU may perform measurements of NR inter-frequency cells of equal or lower priority, or inter-RAT frequency cells of lower priority

SIntraSearchP specifies the Srxlev threshold (in dB) for intra-frequency measurements. SIntraSearchQ specifies the Squal threshold (in dB) for intra-frequency measurements. SnonIntraSearchP specifies the Srxlev threshold (in dB) for NR inter-frequency and inter-RAT measurements. SnonIntraSearchQ, specifies the Squal threshold (in dB) for NR inter-frequency and inter-RAT measurements

When the WTRU decides to perform intra-frequency measurements for cell re-selection based on the criteria above, the WTRU may perform the cell rankings of the concerned cells. Inter-frequency and inter-RAT reselection may be based on absolute priorities where a WTRU tries to camp on the highest priority frequency available. The cell-ranking criterion (referred to as Criteria R) for serving cell (Rs) and for neighboring cells (Rn) may be defined by:

$$\begin{matrix}Rs = Qmeas , s + Qhyst - Qoffsettemp \\ Rn = Qmeas , n - Qoffset - Qoffsettemp\end{matrix}$$

where the following may be applicable, as noted in Table 2:

TABLE 2

| | |
|---|---|
| Qmeas | RSRP measurement quantity used in cell reselections. |
| Qoffset | For intra-frequency: Equals to Qoffsets, n, if Qoffsets, n is |
| | valid, otherwise the equals to zero. |
| | For inter-frequency: Equals to Qoffsets, n plus |
| | Qoffsetfrequency, if Qoffsets, n is valid, otherwise the |
| | equals to Qoffsetfrequency. |
| Qoffsettemp | Offset temporarily applied to a cell. |

The WTRU may perform ranking of all cells that fulfil the cell selection criterion S. The cells may be ranked according to the R criteria specified above by deriving Qmeas,n and Qmeas,s and calculating the R values using averaged RSRP results. If rangeToBestcell is not configured, the WTRU shall perform cell reselection to the highest ranked cell. If rangeToBestcell is configured, then the WTRU shall perform cell reselection to the cell with the highest number of beams above the threshold (e.g., absThreshSS-BlocksConsolidation) among the cells whose R value is within rangeToBestcell of the R value of the highest ranked cell. If there are multiple such cells, the WTRU shall perform cell reselection to the highest ranked cell among them.

The WTRU may reselect the new cell if the following conditions are met: the new cell is better than the serving cell according to the cell reselection criteria specified above during a time interval TreselectionRAT; more than 1 second has elapsed since the WTRU camped on the current serving cell.

The WTRU may be associated with measurement gaps to perform measurements based on the WTRU being unable to measure the target carrier frequency while simultaneously transmitting/receiving on the serving cell.

The WTRU may use measurement gaps to perform inter-frequency and inter-RAT measurements. A gap length may be 6 ms which accommodates 5 ms measurement time (e.g., PSS and SSS are transmitted once every 5 ms) and RF re-tuning time of 0.5 ms before and after the measurement gap. The measurement gap repeats with a periodicity of either 40 ms or 80 ms.

Similarly, in NR, the measurements that the WTRU performs can be gap-assisted (network configures measurement gap) or non-gap-assisted. The need for measurement gap in NR depends on the capability of the WTRU, the active bandwidth part (BWP) of the WTRU and the current operating frequency.

In NR, measurements gaps might be used for intra-frequency, inter-frequency and inter-RAT measurements. Intra-frequency measurements in NR may be associated with a measurement gap, for example, if the intra-frequency measurements are to be done outside of the active BWP. Measurement gap lengths of 1.5, 3, 3.5, 4, 5.5, and 6 ms with measurement gap repetition periodicities of 20, 40, 80, and 160 ms may be defined in NR.

In NR, the RF re-tuning time is 0.5 ms for carrier frequency measurements in FR1 (Frequency Range 1) and 0.25 ms for FR2 (Frequency Range 2), where FR1 defines bands in the sub-6 GHz spectrum and FR2 defines bands in the mmWave (millimeter wave) spectrum. For example, a gap length of 4 ms for FR1 measurements may allow 3 ms for actual measurements, and a gap length of 3.5 ms for FR2 measurements may allow 3 ms for actual measurements.

During the measurement gaps, the measurements are to be performed on SSBs of the neighbor cells. The network provides the timing of neighbor cell SSBs using SS/PBCH Block Measurement Timing Configuration (SMTC).

The measurement gap and SMTC duration may be configured such that the WTRU can identify and measure the SSBs within the SMTC window e.g., the SMTC duration should be sufficient to accommodate (e.g., all) SSBs that are being transmitted. For SSB based intra-frequency measurements, the network may configure a measurement gap in the following:

The network may configure a measurement gap if any of the WTRU configured BWPs do not include the frequency domain resources of the SSB associated to the initial DL BWP.

For SSB based inter-frequency measurements, the network may configure measurement gap in the following cases: the network may configure a measurement gap if the WTRU supports per-FR measurement gaps and if the carrier frequency to be measured is in same FR as any of the serving cells. The network may configure a measurement gap If the WTRU supports per-WTRU measurement gaps. The measurement object can be configured on any frequency range (FR1 or FR2), but the gap will anyway be configured by the network.

Inter-RAT measurements in NR are limited to E-UTRA. For a WTRU configured with E-UTRA Inter-RAT measurements, a measurement gap configuration may be provided in the following: The WTRU supports per-WTRU measurement gaps; the WTRU supports per-FR measurement gaps and at least one of the NR serving cells is in FR1.

Depending on the WTRU capability to support independent FR measurement and network preference, there may be two types of measurement gaps defined in NR: per-WTRU and per-FR. In per-FR gap, two independent gap patterns (e.g., FR1 gap and FR2 gap) may be defined for FR1 and FR2 respectively. Per-WTRU gap may apply to both FR1 (E-UTRA and NR) and FR2 (NR) frequencies. The WTRU may be configured with measurement gap configurations. The main parameters of a measurement gap config may include one or more of the following parameters: A parameter mgrp (Measurement Gap Repetition Period) is the periodicity (in ms) at which measurement gap repeats. Periodicities of 20, 40, 80, and 160 ms may be included in NR.

A parameter gapOffset is the gap offset of the gap pattern. As the offset values points to the starting subframe within the period, its value range may be from 0 to mgrp-1. For example, if the periodicity is 40 ms, the offset may range from 0 to 39. A parameter mgl (Measurement Gap Length) is the length of measurement gap in ms. Measurement gap lengths of 1.5, 3, 3.5, 4, 5.5, and 6 ms may be defined in NR.

A parameter mgta (Measurement Gap Timing Advance) may be included. When configured, the WTRU may start the measurement mgta ms before the gap subframe occurrence e.g., the measurement gap starts at time mgta ms advanced to the end of the latest subframe occurring immediately before the measurement gap. The amount of timing advance may be 0.25 ms (FR2) or 0.5 ms (FR1).

NES support for TN cells may occur in connected mode. A cell may employ power domain, spatial domain, and time domain (cell DTx) techniques to save energy. For cell DTx, a groupcast based DCI indication may be sent to WTRUs in connected mode. NES support impacting idle mode WTRUs may be enabled. NTN-TN interactions and overlapping NTN-TN coverage may not be leveraged to save network energy.

One or more of the following may be applicable: overlaid coverage of terrestrial network (TN) and non-terrestrial network (NTN) cells; same operator for TN and NTN or service level agreements between TN and NTN operators (if different operators) to allow WTRUs to use resources over NTN; WTRUs capable of camping on TN or NTN cells; a TN cell/beam overlapping with large number of TN cells; or limited number of WTRUs within the coverage of a TN cells.

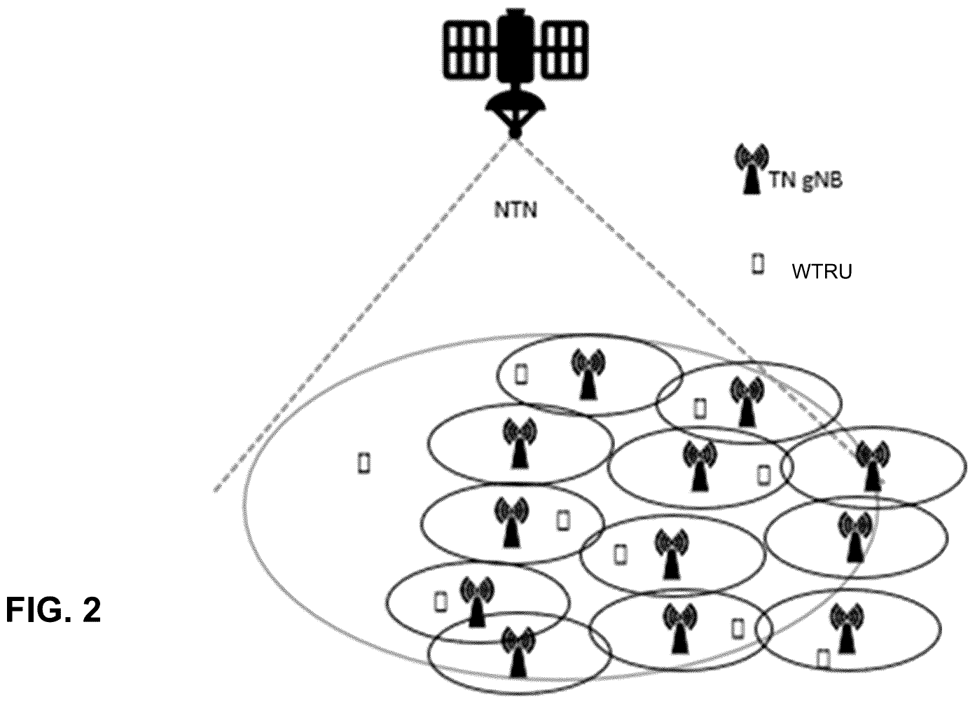

Features described herein may be associated with idle and inactive mode WTRUs for network energy saving. FIG. 2 illustrates an NTN cell overlap shown with dozens of TN cells with a limited number of WTRUs per TN cell. When an NTN cell is able to provide coverage overlapping with several TN cells, the TN cells may be switched off to save energy based on there being a limited number of WTRUs in those cells.

The TN cell may enable the WTRUs in the cell to have sufficient NTN coverage. If an NTN cell is illuminating fully the coverage area of a TN cell, due to WTRUs' being indoor, non-LOS conditions, etc., the WTRUs may not be able to camp on NTN cells. The cell (re-)selection procedure may be updated to incorporate the TN (or NTN) cells being (or planning to be) in sleep mode. There may be triggers WTRUs to reselect to NTN cells based on the TN cell being planning to go deep sleep. The WTRUs may re-select to NTN based on triggers and update to a re-selection procedure. WTRU may wake-up a TN cell while under dual coverage (e.g., via an NTN cell, e.g., to initiate an MO call). An NTN cell coverage may disappear (e.g., satellite moves out), or degrade (e.g., WTRU in non-LOS).

Latency and QoS provisions with NTN cells may not be suitable for the WTRUs in case the WTRUs have to initiate a low latency communication. Continuous coverage for WTRUs may occur as (e.g., some) TN or NTN cells enter energy saving mode.

A WTRU may wake up a TN cell based on losing an NTN cell (e.g., determining that the NTN cell is unsuitable), where the WTRU may have selected the NTN cell based on a different TN cell becoming unavailable. In examples, a WTRU camped over a TN cell may detect a first indication to validate if an NTN cell is suitable. The WTRU may make measurement(s) over (e.g., on, associated with, etc.) the indicated NTN cell and evaluate the measurement(s) to determine if they fulfill condition(s) (e.g., configured conditions). The WTRU may detect a second indication whereby the TN cell indicates its shut-down. Based on the second indication, the WTRU may exclude TN cell(s) (e.g., comprising the TN cell that is shutting down) from re-selection candidates and re-select to an NTN cell. Based on the NTN cell becoming (e.g., the WTRU determining that the NTN cell is or will become) not available/suitable (e.g., due to NTN power sharing/link conditions), the WTRU may wake up a SLEEPING TN cell to camp on and/or reselect to (e.g., where the sleeping TN cell may be a cell that is not one of the excluded TN cells).

A WTRU may perform one or more of the following associated with waking up a TN cell.

A WTRU may be camped on a TN cell and/or be configured with one or more of the following: a configuration for NTN cells to perform measurements in IDLE/INACTIVE mode (e.g., the WTRU may receive characteristics of the NTN cells (e.g., LEO, MEO, GEO), power sharing status and SIBs (e.g., SIB19); a first message configuration, e.g., to validate that at least one of the NTN cells is suitable; a second message configuration for a message indicating a TN cell(s) is shutting down; and/or an UL-WUS configuration to use to wake-up a TN cell with validity conditions.

The WTRU may detect/receive a first message indicating to validate that at least one of the NTN cells is suitable, wherein the first message may be an explicit indication (e.g., paging message, or SI update message or DL-WUS, freq priority update indication SIB, etc.) or an implicit indication (e.g., reduced/modified/SIB1-less SSB, etc.).

In some examples, the (e.g., power saving) WTRU may select NTN cell(s) on which to perform measurements based on one or more of the following: an NTN Beam power sharing status (e.g., if provided by TN cell); cell(s) of a specific orbit (e.g., WTRU may select GEO cells (e.g., only GEO cells), e.g., to avoid frequent re-selections and/or SI maintenance); a WTRU power status (e.g., if WTRU is a plugged device, CPE, etc.); or a WTRU local mobility estimate (e.g., fixed or static vs WTRU in mobility).

The WTRU may determine the selected/indicated NTN cells being suitable based on one or more of the following conditions: an NTN Beam power sharing status (e.g., received from TN and/or NTN or detected from signal(s)) (e.g., inactive periodicity less than T, active beam power reduction less than P); cell(s) of a specific orbit (e.g., WTRU may select GEO cells, e.g., to avoid frequent re-selections and/or SI maintenance); an RSRP of the RS (e.g., SSB) is better than a threshold (e.g., with/without compensated measurements if NTN cells under Beam power sharing). Examples described herein may be performed if no suitable cell is found.

In some examples, the WTRU may detect and/or receive a second message from a TN cell indicating a shut-down of TN cell(s) (e.g., single TN cell, RNA/TAC cells, etc.), for example after a threshold duration where the second message may be an explicit indication (e.g., paging or SI update message or DL-WUS, frequency priority update indication SIB) or an implicit indication (e.g., reduced/modified/SIB1-less SSB etc.). The type of second message may be based on the type of the first message.

The WTRU may exclude TN cell(s) (e.g., camped cell or the intra-frequency or same RNA/TAC, or all TN) as candidate(s) for cell selection/reselection for a configured duration T (e.g., 300 seconds). If the WTRU received the second message, the excluded cells may be the indicated TN cell(s). The WTRU may camp over the NTN cell (e.g., as by-product of previous exclusion step of TN cells).

The WTRU may detect an NTN cell becoming unavailable in the future (e.g., at a future time) due to NTN Power Sharing (e.g., DTx period larger than T, power-sharing larger than P) or T_Service (e.g., WTRU losing service coverage). The NTN cell may provide service/power indication and (broadcast) assistance to the WTRU, e.g., an UL-WUS config for TN cell(s) (e.g., a third TCN cell).

The WTRU may transmit a UL-WUS to the (e.g., sleeping) TN cell (e.g., a third TN cell) according to the received WUS configuration, e.g., if one or more of the following conditions are satisfied: time validity for UL-WUS configuration(s) are valid (e.g., config timer has not expired); a location validity for UL-WUS configuration is valid (e.g. WTRU distance from a reference location); or a number of re-transmissions according to the UL-WUS configuration (e.g., a number of re-transmissions according to the UL-WUS configuration satisfies a threshold). The WTRU may detect SSB and/or SIB(s) from the TN cell (e.g., the TN cell to which the UL-WUS was sent) and may perform re-selection to the TN cell.

Features described herein may be associated with higher network energy saving for TN and NTN cells while enabling the smooth operation for WTRUs in idle/inactive mode. TN-TN idle mode WTRU mobility may be associated with network energy savings

Network energy saving may incorporate TN and NTN networks. In an example, the TN and the NTN networks may be operated by a single operator where the WTRUs may be allowed (e.g., made to) camp on TN or NTN. In an examples, the TN and the NTN may be operated by (e.g., different) operators whereby the WTRUs may be allowed to camp on (e.g.,) of the networks under (e.g., different) types of agreements between the operators. The interactions between TN and NTN networks may be based on the WTRU subscription.

An energy saving state for the cell may describe the energy saving state for both TN and NTN types of cells. An energy saving sate may imply one or more of the following being employed at the cells: power domain adaptations; spatial domain adaptations; cell DTx/DRx; cells transmitting modified forms of common signals/channels (e.g., no SIBs, no SIB1, modified periodicity for SSB, no SSB, modified SSB structure, slim SSB, PBCH less SSB including of PSS/SSS, new sync signals, DL-WUS signals; beam on/off a cell (e.g., a satellite) that may turn beams on/off according to a rule (e.g., a periodicity, a pattern, load criteria, etc.); power sharing among different beams based on a cell that may be sharing the power among different beams following suitable criteria; or any combination of the above.

Power saving and power sharing may be used interchangeably herein. Power saving and power sharing may include cell level or beam level power saving/sharing techniques as described herein.

A power sharing status may include types of energy saving techniques employed by a cell (e.g., a TN cell or an NTN cell) at a cell or beam level. The power sharing status may be a mapped value or an indication, which may map to a suitable combination of power sharing technique and may be indicated to the WTRU by the cell employing one of the power sharing techniques or WTRU's camped cell. In examples, the WTRU may determine the power sharing status of a cell or beam itself based on the received signals from the cell or beam.

A UL-WUS signal may describe a signal that a WTRU may be configured to transmit in the UL direction to a cell to change/modify/update its network energy saving state. For example, the WTRU may transmit the signal to wake up a cell that is in deep sleep mode and transmitting a signal. In examples, the WTRU may transmit the signal to request SIBs (e.g., SIB1) transmissions from a cell which is transmitting SSBs. In examples, the WTRU may transmit UL-WUS to a cell employing beam power sharing to transmit without beam power sharing, e.g., turning the beam on, or increasing the transmit power of the beam etc. In examples, UL-WUS may be a request to wake-up a TN cell, wake up an NTN cell, a request to turn a beam on, a request to increase the transmit power for a beam/cell, a request to update the cell/beam DTx period etc. The request to wake-up or change the energy saving state to a given state may be known to WTRU/network through configuration, pre-configuration, specification, or indicated as part of the UL-WUS signaling through implicit or explicit indication.

A configuration may support NTN-TN NW energy savings. A WTRU may receive configuration to support network energy saving. The WTRU may receive the configuration while in connected mode. The WTRU may receive the configuration to support NW energy saving in idle or inactive mode. The configuration signaling to support NW energy saving may be based on the RRC state of the WTRU.

In examples, the WTRUs may receive part of the configuration while being in one RRC state (e.g., in connected mode) with a (e.g., one) type of the network (e.g., a TN cell or an NTN cell). The NW (e.g., the TN cell or the NTN cell) may complement, update or override the NW energy saving configuration for the WTRU in a second RRC state (e.g., Idle mode). The two RRC states of the WTRU may be the same or different. In examples, the WTRU may receive part of the configuration from a cell, which may be complemented/modified/updated from a different cell (e.g., TN cell or NTN cell). The modification/update of the configuration may happen after WTRU performing cell re-selection to a different cell.

The WTRU may receive the NW energy saving configuration through one or more of the following signaling examples: cell level Broadcast signaling; groupcast signaling where the WTRU may be part of the group destined to receive the signaling; part of RRC configuration; dedicated signaling for the WTRU; neighbor cell configuration signaling though the dedicated SIBs or new SIBs; or implicit indication through transmission of broadcast signals (e.g., SSB/SIBs etc.)

The WTRU may receive the NW energy saving configuration including one or more of the following.

The NW energy saving configuration may include an indication of one or more cells (e.g., TN cells or NTN cells), one or more SIBs for the indicated cells (e.g., SIB-19).

The NW energy saving configuration may include a coverage indication of the cells where the coverage indication can be provided through different parameter settings. In examples, the coverage indication for a cell may be indicated by a reference location with a radius where the WTRU may determine itself being in-coverage by determining its location and evaluating whether its distance from the reference location is smaller than the radius. In examples, different coverage shapes, such as polygons etc. may be configured for a cell coverage.

The NW energy saving configuration may include a set of measurement configuration for one or more cells (e.g., neighbor cells, TN cells, NTN cells etc.) to perform measurements. The measurements may be Idle/inactive mode or RRC connected mode measurements.

The NW energy saving configuration may include characteristics of the (neighbor) cells (e.g., the cells being TN cells, the cells being NTN cells, and/or the type/nature of the orbit for the NTN cells, e.g., LEO, MEO, GEO).

The NW energy saving configuration may include an energy saving status of the cells (e.g., cell DTx, SSB cell, modified SSB/slim SSB, beam power sharing e.g., beams illuminating periodically beam DTx, beams turning on/off, beams turning on/off with specific/configured/indicated patterns).

The NW energy saving configuration may include an indication of a cell being not available or out of service or shut down after a configured/indicated/specified duration, e.g., an NTN cell may provide the configuration of being out of service based on an explicit or implicit indication.

The NW energy saving configuration may include an indication of a cell being not available or not available for a specific service due to a specific energy saving mechanism. For example, an NTN cell may configure its use of beam power sharing or another specific energy saving mechanism with a start time in future with appropriate parameter.

The NW energy saving configuration may include a first indication configuration, e.g., to validate that at least one of the cells is suitable.

The NW energy saving configuration may include a second indication configuration whereby the second indication may indicate the change of energy saving status for one or more of the cells (e.g., the cell WTRU is camped on, one or more of the neighboring cells).

The NW energy saving configuration may include a UL-WUS configuration to request a cell modify/update its network energy saving state, e.g., a request to wake-up a TN cell, a request to turn a beam on, a request to increase the transmit power for a beam/cell, a request to update the cell/beam DTx period etc.

The cell providing the configuration may provide a UL-WUS configuration for itself, that the WTRU may use if it determines to wake up the same cell later.

The cell providing the UL-WUS configuration may provide UL-WUS configuration for other cells, e.g., a (e.g., one) UL-WUS configuration for an indicated cell, one UL-WUS configuration for the cells of a (e.g., one) type (e.g., TN cells or NTN cells), a (e.g., one) UL-WUS configuration associated to RNA or TAC, or PLMN, etc.

An indication to validate neighbor cells may be detected/received. A WTRU may detect or receive an indication (e.g., a first indication) from the network to validate at least one of the neighbor cells. The WTRU may receive the indication from the cell it is camped on, or it may be a different cell that the WTRU is configured to receive/detect the indication from, e.g., a macro cell or a stable cell that WTRU is configured to detect the indication from. The WTRU may receive the indication in RRC connected state. The WTRU may be configured to detect/receive the indication from a TN cell or from an NTN cell.

The WTRU may detect/receive the indication to validate that at least one of the cells (e.g., configured cell, indicated cell, detected cell) is suitable according to some known/configured/indicated criterion. The suitable may imply a cell being suitable cell selection, re-selection procedure. The WTRU may be configured with conditions to verify related to cell/beam nature (e.g., TN cell or NTN cell, LEO/MEO/GEO satellite etc.), or energy saving state of the network/beam/cell). These conditions may complement/update/modify/replace the conditions/criterion of cell (re-)selection.

The WTRU may detect the first indication through explicit signaling, e.g., by receiving a first message from the network. The message received by the WTRU could be a paging message, a paging early indication message, a SI update message/indication, a type or modified version of DL-WUS signal/message, freq priority update indication message in SIB etc.

The first indication received by the WTRU may be an implicit indication. The WTRU may detect the implicit indication by detecting a change in one of the DL signal transmissions. The implicit indication may be any one of the following: change in the periodicity of SSB transmission; change in the structure of SSBs transmission (e.g., reduced/modified/SIB1-less SSB etc.); change in the structure of system information transmission (e.g., SIB1 not being transmitted, other SIBs not being transmitted); change in one of the physical properties of common channels and signals e.g., SSBs, SIBs, paging channels etc.; change in the power/spatial domain energy saving mechanism for the cells/beams; change in the cell/beam DTx/DRx where the change may be in the periodicity, active duration, inactive duration etc.; or change in the beam power sharing where the change may be in the power level, periodicity, pattern, on/off duration etc.

A WTRU may determination cells characteristics by reading SIB. A WTRU may detect the presence of cells (e.g., TN cells or NTN cells). The WTRU may detect the presence of cells by trying to detect synchronization signal blocks (SSBs) and system information. The WTRU may use the information about the frequency bands and carriers it may have. The information about the frequency bands and carriers may be the stored information at the WTRU, e.g., in the universal subscriber identity module (USIM). The information may be provided to the WTRU in one of the previous connections to the network. The WTRU may receive the information from its camped cell

Upon detecting the presence of the cells, the WTRU may read system information from the cells. The WTRU may read SSB and other SIBs. The other SIBs may include SIB1, SIB19 and other SIBs. The WTRU may determine the nature of the cells (e.g., TN cells or NTN cells) based on the received system information. For the NTN cells, the WTRU may determine the nature of the orbit/constellation type for these NTN cells. The constellation types may include LEO, MEO or GEO constellations. The WTRU may determine the service continuity of the satellites by reading the system information for these NTN cells.

A WTRU may select/determine cells. A WTRU may determine cells as validation candidates based on local power/battery status, local mobility level/status, cell type, cell nature, satellite characteristics etc. The WTRU determination may be based on any one of the following factors: WTRU power status (e.g., if WTRU is a plugged device, CPE); WTRU local mobility estimate (e.g., fixed WTRU, a static, a WTRU in mobility); cell type (e.g., TN cells vs NTN cells); based on the type/nature of the cell that WTRU detects/receives the first indication (e.g., whether the cell providing the first indication is a TN cell, an NTN cell, an NTN cell with a specific orbit (e.g., LEO/MEO/GEO, UAV or HAPS) etc.; NTN Beam power sharing status (e.g., if provided by TN cell); or cells of a specific orbit (e.g., WTRU may select GEO cells to avoid frequent re-selections and SI maintenance).

The factors based on which WTRU performs cells determination (or selection) may be provided to the WTRU by the network, e.g., as part of configuration to support network energy saving, or as part of the indication to validate cells, as described herein. In examples, the WTRU may be determining some of the factors to determine/select cells, e.g., by detecting signals from those cells, and/or by reading system information from those cells, as described herein. In some examples, the WTRU may determine the factors for cells determination/selection.

The WTRU determination may comprise of selecting a subset of cells from the set of configured/indicated/detected cells for suitability validation. For example, a WTRU may determine to validate a subset of cells e.g., for configured/indicated/known conditions/measurements. The WTRU may be configured to determine/select at least one cell for further validation.

A WTRU may determine to select or prioritize cells. The WTRU may determine to prioritize cells based on the type of cells, e.g., whether TN cells or NTN cells. The WTRU may determine to prioritize cells based on the type of energy saving mechanism/procedure they are employing, e.g., the WTRU may prioritize cells which are not employing any energy saving. The WTRU may determine to prioritize cells employing a specific energy saving mechanism over the cells employing a different type of energy saving mechanism. e.g., the WTRU may prioritize cells employing cell DTx over cells employing reduced power transmission. The WTRU may prioritize cells (e.g., NTN cells) based on the type of constellation they are part of. In examples, the WTRU may prioritize GEO cells over LEO cells. The WTRU may prioritize the type of the NTN constellation based on the WTRU's active, expected traffic parameters (e.g., requirements) based on being known to the WTRU. The WTRU may prioritize the type of the NTN constellation based on whether the WTRU is a plugged device (e.g., customer premise equipment) or if the WTRU is a battery powered device. The WTRU may prioritize the type of the constellation based on battery power levels. For example, the WTRU may prioritize GEO satellites (e.g., as re-selection candidates) based on its battery power level being below a threshold, e.g., battery less than 50%, to avoid frequent re-selections and making measurements. The WTRU may prioritize LEO based constellations if its battery power level is above a threshold and/or it expects to initiate a service requiring lower latency or higher QoS.

The WTRU may prioritize the cells (e.g., NTN cells) based on the type of the power saving/sharing mechanism employed by the cells. The WTRU may prioritize the cells based on the parameters of the power saving/sharing mechanism employed by the cells. For example, the WTRU may prioritize the cells employing beam power sharing such that on/off periodicity is below a threshold, or active duration is larger than a threshold, or power reduction in the beams is smaller than a threshold.

The WTRU may select or prioritize the cells based on the type/nature of the cell that WTRU detects/receives the first indication (e.g., whether the cell providing the first indication is a TN cell, an NTN cell, an NTN cell with a specific orbit (e.g., LEO/MEO/GEO, UAV or HAPS) etc. In examples, the WTRU may select the NTN cells if it receives the indication from a TN cell or may select the TN cells if it receives the indication from NTN cell. In examples, the WTRU may be configured to select the cells of a specific orbit based on the cell from which the WTRU detects/receives the first indication.

In examples, the WTRU may be provided with the information of some factors for the selection/determination by the network, and the WTRU may perform cells determination/selection based on any suitable set of factors in one step.

In examples, the WTRU may have the knowledge of a subset of factors for cell determination/selection, e.g., through local knowledge, network configuration etc., and it may acquire the remaining ones to be used by detecting/reading some signals from the cells. Once the information about the factors is complete, the WTRU may perform cell selection.

In some examples, WTRU determination/selection of cells may be a two-step procedure. The WTRU may perform a first selection based on local power/energy/mobility factors. For the selected cells, the WTRU may determine the type/nature of cells/orbits by detecting/reading some signals from the cell. This may occur, based on the WTRU having missing factors based on which cell selection needs to be performed. The WTRU may perform (e.g., further) selection of the cells based on the determined factors (type/nature of cells/orbits etc.). The WTRU may be configured to employ two-step selection for example based on not being provided (e.g., some of) the factors.

A WTRU may perform measurements over neighbor cells. A WTRU may perform measurements over a set of cells. The set of cells may be determined by the WTRU based on local WTRU power/battery status, local WTRU mobility, type of the cell (e.g., TN cells or NTN cells), characteristics of the cells (e.g., LEO/MEO/GEO or UAV/HAPS etc.), as described herein. The set of cells may be TN cells or NTN cells. The set of cells may be known to be the neighbor cells, either through configuration or WTRU based detection. The set of cells may be intra-frequency or inter-frequency cells. The set of cells may be the detected cells or the ones that were provided to the WTRU by the network, e.g., by the cell that the WTRU is camped on.

A WTRU may perform measurements based on (pre-) configuration, wherein the measurements may be for intra-frequency, inter-frequency or inter-RAT measurements. These measurements may be for detected cells, configured cells or indicated cells. The WTRU may make measurements over SSBs, CSI-RS, discovery signals, or any other type of reference signals.

The measurement configurations may comprise of measurements objects, measurement signals to use, time/frequency resource indication, periodicity of signals, QCL properties etc. The WTRU may be configured to make measurements for one or more of the following quantities:

SS reference signal received power (SS-RSRP); CSI reference signal received power (CSI-RSRP); SS reference signal received quality (SS-RSRQ); CSI reference signal received quality (CSI-RSRQ); SS signal-to-noise and interference ratio (SS-SINR); CSI signal-to-noise and interference ratio (CSI-SINR); SRS reference signal received power (SRS-RSRP); received Signal Strength Indicator (RSSI); DL PRS reference signal received power (DL PRS-RSRP); or DL reference signal time difference (DL RSTD).

A WTRU may perform filtering on the measurements. The WTRU may perform filtering with parameters such as number of samples and filtering coefficients, etc. The WTRU may have the knowledge of filtering configuration/parameters from (pre-) configuration, indication, or through the specification.

A WTRU may apply compensation to measurements. The WTRU may update the measured or estimated quantities from the received radio signals. The WTRU may update the measurements based on the network energy saving state. As an example, if the measurements are made over the signals/channels from a given cell/beam, the WTRU may apply the updates/compensations to these measurements based on the given cell/beam being in a given/known network energy saving state. The compensation applied to the measurements may be configured to the WTRU by the network, or may be known to the WTRU, e.g., through specifications. The WTRU may be configured to apply the compensation offsetting the impact of energy saving technique used by the transmission entity, e.g., if a cell is applying power reduction of P for the transmission of SSBs (at least), the WTRU may apply the compensation equal to the power reduction P to the measured power from SSB signals, offsetting the impact of energy saving technique. The WTRU may be configured to apply a different compensation factor compared to the factor used by the network for energy saving. The WTRU may be configured to apply the compensation to the measurements based on configuration, based on implicit or explicit indication by the network, based on broadcast signaling e.g., through SIBs, based on paging or paging early indication, or based on detection of network energy saving mechanism through any means.

A WTRU may determine the energy saving state of a cell or a beam. The WTRU determination of energy saving state of the cell may be one or more of the following: the cell employing power/spatial reduction; the cell employing cell DTx/DRx; the cell employing any of the micro/macro/deep sleep; the cell employing any of the beam power sharing mechanism; the cell in any of the limited state (SSB, SIB1, etc.); the cell in common channel state (e.g., common channel only state); or the cell available to all WTRUs.

The WTRU may determine the energy saving state of a cell based on receiving SSBs, SIBs (e.g., SIB1, or any other SIBs) etc. The WTRU may determine the energy saving state of a cell based on implicit or explicit indication. For an implicit indication, the WTRU may determine the energy saving state of a cell based on any one of the physical properties of the SSBs/SIBs or other signals received from the cell. The WTRU may determine the energy saving state of the cell based on explicit indication from the cell through SSB, SIB or a form of dedicated signaling.

A WTRU may determine the characteristics of a cell. The WTRU determination for the cell characteristic may be one or more of the following: the cell being a terrestrial cell, a TN cell; the cell being an NTN cell; the cell being or not a store & forward cell; the cell with some gateway properties, e.g., gateway ground station in a particular country etc.; the cell orbit from any one of the LEO/MEO or GEO orbits; or the cell orbit properties e.g., longitudinal, latitude or other properties.

The WTRU may determine the characteristics of a cell based on receiving SSBs, SIBs (e.g., SIB1, SIB19 or any other SIBs) etc. The WTRU may determine the characteristics of a cell based on implicit or explicit indication. For implicit indication, the WTRU may determine the characteristics of a cell based on any one of the physical properties of the SSBs/SIBs or other signals received from the cell. The WTRU may determine the characteristics of the cell based on explicit indication from the cell through SSB, SIB1, SIB19, other SIBs or any other form of common or dedicated signaling.

The WTRU may determine suitable cells. A WTRU may determine one or more cells to be suitable based on one or more conditions to be fulfilled. The set of the cells that are input to the WTRU determination for suitable cells may be one or more of the following: in examples, the cells may be provided to the WTRU as part of the network energy saving configuration, as described herein; in examples, the cells are detected by the WTRU, for example according to a known/configured criterion; or in examples, the cells may have undergone a selection at the WTRU based on WTRU local power/energy, WTRU type, WTRU mobility, cell type, cell characteristics, cell orbit etc., as described herein.

The WTRU may make measurements over the cells. The WTRU may determine the cells being suitable based on one or more of the following factors/conditions. The WTRU may determine the cells being suitable based on an NW energy saving status of the cell/beam including power, spatial, time domain adaptations, cell DTx/DRx, beam power sharing, beam on/off (with a period, a pattern, etc.). The WTRU may have different parameters and different states for TN cells vs NTN cells to consider them suitable or not. The WTRU may be configured with thresholds to determine if the cells/beams employing power domain reduction are suitable or not. The thresholds and parameters may be based on the type of cells, e.g., TN cells vs NTN cells, and/or the nature of the orbit, e.g., LEO/MEO/GEO or UAV/HAPS etc. The WTRU may apply conditions based on beam power sharing status, e.g., the WTRU may determine the beams suitable if the periodicity is smaller than a configured threshold T1 or if the active duration within the periodicity is larger than another threshold T2. The WTRU may apply conditions to beam power reduction, e.g., the WTRU may determine a cell suitable if the power reduction for the beam is smaller than a configured threshold P1. The WTRU may be configured to apply conditions based on multiple factors being impacted due to network energy savings, e.g., the WTRU may be configured to consider a cell suitable if the beam sharing periodicity is smaller than a threshold T3 and/or the power reduction during the active time is less than P2. The WTRU may be configured with conditions over different dimensions of network energy saving, such as power domain, time domain, spatial domain adaptations.

The WTRU may determine the cells being suitable based on cell type (e.g., TN cells vs NTN cells). The WTRU may determine the cells being suitable based on cells of a specific type/orbit among LEO/MEO/GEO/UAV/HAPS or other types of TN and NTN cells (e.g., WTRU may select GEO cells to avoid frequent re-selections and SI maintenance). The WTRU may determine the cells being suitable based on WTRU power status (e.g., if WTRU is a plugged device, CPE). The WTRU may determine the cells being suitable based on WTRU local mobility estimate (e.g., fixed WTRU, a static, a WTRU in mobility) based on WTRU local knowledge, or WTRU location determination at one/several instance or in a window. The WTRU may determine the cells being suitable based on WTRU measurements made over signals/channels, as described herein. The WTRU may use measurements, compensated measurements, or a combination. The WTRU may determine a cell being suitable if RSRP of the RS (e.g., SSB) is better than a threshold (with/without compensated measurements if TN/NTN cells under any energy saving mechanism, such as Beam power sharing etc.).

The WTRU may determine the cells being suitable based on based on the type/nature of the cell that WTRU detects/receives the first indication (e.g., whether the cell providing the first indication is a TN cell, an NTN cell, an NTN cell with a specific orbit (e.g., LEO/MEO/GEO, UAV or HAPS) etc. If no suitable cell is found, the WTRU may perform action(s) as described herein.

The WTRU may evaluate a set of cell (e.g., indicated cells or detected cells for suitability. The WTRU may be configured to evaluate all the indicated cells. In some examples, the WTRU may be configured to stop evaluation as soon as at least one cell is found suitable according to the configured suitability conditions. In some examples, the WTRU may evaluate cells after finding at least one suitable cell based on a condition, e.g., if WTRU is a plugged device, or if WTRU batter level is better than a threshold, or if the suitable cell is not good enough based on the measurements on the suitable cell.

The WTRU may determine the signaling for a second indication. A WTRU may determine the type/nature of the signaling to receive an indication, e.g., a second indication. In examples, the WTRU may be configured to detect/receive the second indication implicitly or explicitly, as described herein.

In examples, the WTRU may determine the type/nature of the signaling to receive the second indication based on one or more of the following. The WTRU may determine the type/nature of the signaling to receive the second indication based on a nature/type of the signaling with which the WTRU receives the first indication from the network. In examples, the WTRU may be configured to receive the second indication explicitly if it received the first indication explicitly/implicitly or vice versa. In examples, if the first indication is received through the cell not transmitting SIBs (e.g., SIB1 etc.), the second indication may be in the form of updated periodicity or change of structure for SSBs.

The WTRU may determine the type/nature of the signaling to receive the second indication based on the first indication may provide the information for the type/nature of the signaling used for the second indication in an explicit or implicit manner.

The WTRU may determine the type/nature of the signaling to receive the second indication based on the type of the cell (e.g., whether TN or NTN cell), which the WTRU is camped on while receiving the first/second indication.

The WTRU may determine the type/nature of the signaling to receive the second indication based on the energy saving state/status of the cell where the WTRU is camped on.

The WTRU may determine the type/nature of the signaling to receive the second indication based on the energy saving state of the cell(s) for which the WTRU receives the first indication for suitability validation.

The WTRU may provide a stay awake indication to the network. A fallback may be based on no suitable cell being available.

The WTRU may transmit the stay awake indication to the TN cell based on determining that there is no suitable NTN cell. The stay awake indication may be one or more of: transmitted over a common/shared resource (e.g., cell specific resource); or based on RACH/UL-WUS/SRS transmission.

A WTRU may provide an indication to the network, e.g., stay awake indication, after detecting/receiving a first indication from the network where the first indication is detected/received, as described herein.

The WTRU may transmit stay awake indication to the network based on one or more of the following.

The WTRU may transmit stay awake indication to the network based on the WTRU selection/determination of cells, as described herein, wherein for example, the WTRU can transmit stay awake indication if it selects no cell for further measurements.

The WTRU may transmit stay awake indication to the network based on the type of the cells (e.g., TN cells, or NTN cells etc.) indicated/detected where WTRU considers these candidates not compliant or suitable, as described herein.

The WTRU may transmit stay awake indication to the network based on the target orbits not suitable for the configured/indicated/detected cells either known through configuration or detected by WTRU (e.g., by reading system information)

The WTRU may transmit stay awake indication to the network based on the measurements on the configured/indicated/detected cells/beams, e.g., based on measurements (or compensated measurements) not being satisfactory, e.g., not fulfilling the criterion for cell/beam being suitable, as described herein.

The WTRU may transmit stay awake indication to the network based on the WTRU expects to start a service with some QoS for which WTRU deems the configured/indicated/detected cells not suitable

The WTRU may transmit stay awake indication to the network based on transmitted a stay awake indication to the network after receiving a first indication. In case, the network fails to detect/receive/decode the stay awake indication from the WTRU after the transmission of first indication, the network may proceed to shutting down the cell by sending The WTRU may transmit a stay awake indication to the network based on the WTRU having issue with its location determination or any component/process with GNSS based location determination.

The WTRU may receive a second indication. Upon detecting the second indication, the WTRU may send stay awake indication again to avoid the network applying energy saving state based on the WTRU not having a suitable cell. The WTRU may be configured with parameters for a stay awake indication transmission based on receiving a second indication, e.g., the WTRU may be configured to use higher transmission power compared to a stay awake being transmitted based on the first indication, or a different resource, or a different sequence. There may be a subset of parameters specific to the transmission of stay awake indication when it is transmitted based on WTRU detecting a second indication from the network.

The WTRU can transmit the stay awake indication to the cell that it is camped on. In examples, the WTRU may be configured to transmit the stay awake indication to one of the stable or macro cell that it is configured to transmit stay awake indication.

The WTRU may transmit a stay awake indication according to the configuration/indication which can be implicit or explicit. The stay awake indication may be a form of RACH signaling, a form (e.g., updated/modified form) of UL-WUS signaling, a form (e.g., updated/modified form) of uplink SRS signals etc.

The WTRU may detect/receive a second indication from the network. A WTRU may detect or receive an indication (e.g., a second indication) from the network, indicating a change in the network energy saving state. The WTRU may receive the indication from the cell it is camped on, or it may be a different cell that WTRU is configured to receive/detect the indication from, e.g., a macro cell or a stable cell that WTRU is configured to detect the indication from. The WTRU may receive the indication in any of the RRC states, e.g., RRC Idle, RRC Inactive or RRC connected state. The WTRU may be configured to detect/receive the indication from a TN cell or from an NTN cell.

The WTRU may detect the second indication through explicit signaling, e.g., by receiving a message from the network. The message received by the WTRU may be a paging message, a paging early indication message, a SI update message/indication, a type or modified version of DL-WUS signal/message, a freq priority update indication message in SIB, etc.

The second indication received by the WTRU may be an implicit indication. The WTRU may detect the implicit indication by detecting a change in one of the DL signal transmissions or having a timer expired after receiving the first indication. The implicit indication may be one or more of the following: a change in the periodicity of SSB transmission; a change in the structure of SSBs transmission (e.g., reduced/modified/SIB1-less SSB etc.); a change in the structure of system information transmission (e.g., SIB1 not being transmitted, SIBs not being transmitted); a change in a physical property of common channels and signals e.g., SSBs, SIBs, paging channels etc.; a change in the power/spatial domain energy saving mechanism for the cells/beams; a change in the cell/beam DTx/DRx, wherein the change may be in the periodicity, active duration, inactive duration etc.; a change in the beam power sharing, wherein the change may be in the power level, periodicity, pattern, on/off duration etc.; or an expiry of a timer, wherein the timer may be configured with a specific value (e.g., an initial value where the value may be from a set of pre-configured values, and a suitable value can be indicated to the WTRU), and the WTRU is configured with a start time for the timer based on the WTRU starting to decrement the timer (e.g., the detection of the first indication, or the detection of any of the change in DL signals transmitted by the cell/beam). The timer value and how/when to decrement may be configured to the WTRU in suitable scales. In examples, the timer value may be configured in m-see, and the WTRU may be configured to decrement the value by 1 a m-sec. In examples, an additional condition may be configured to the WTRU to decrement the timer. The conditions may be based on detecting a change in DL signals or based on measurements (e.g., SSB measurements going below certain threshold, or detected SSB periodicity increasing to a certain value, or detected SSB periodicity changing more than a certain value from its prior detected value, etc.)

Based on detecting/receiving a second indication, a WTRU may determine the scope of the network energy saving mechanism, e.g., which cells, beams may be impacted by the network energy saving mechanism. The WTRU may be configured with one or more of the following as scope of the network energy saving mechanism indicated based on the second indication: the cell/beam WTRU is camped on; the cell/beam WTRU receives the first/second indication from; (e.g., all) the neighbor cells (e.g., configured/indicated/detected) of the same type (e.g., TN vs NTN cells) as the cell providing the first/second indication; (e.g., all) the cells sharing the same RAN notification area or tracking area code as the cell where WTRU is camped on or through which WTRU receives the first/second indication; (e.g., all) the cells of the same PLMN as the cell where WTRU is camped on or through which WTRU receives the first/second indication; (e.g., all) the cells of the type of the cell where WTRU detects/receives the first/second indication (e.g., if the WTRU receives the first/second indication from a TN cell, the WTRU may assume that all the TN cells will be impacted by the indicated energy saving mechanism).

A WTRU may determine a change in the energy saving state of the network based on detecting/receiving a second indication where the second indication is detected/received, as described herein. The change in the energy saving state may start at a configured/indicated/known time after the first/second indication. The change in the energy saving may impact the cells/beams according to the scope determined by the WTRU. For the change in the energy saving state of the network, the WTRU may be configured to assume one or more of the following: the cell/beam entering/employing any of energy saving techniques, e.g., spatial/power domain adaptations, temporal adaptations (e.g., cell DTx/DRx etc.) at cell or beam level, cell or beam level power sharing techniques; the cells or beams transmitting common channels and signals; the cells or beams transmitting SSBs or limited form of synchronization signals; the cells or beams transmitting SIB less, SIB1 less, modified periodicity SSB or any other limiting form of signals; the cells or beams entering any level of sleep mode; the cells or beams completely shutting off transmissions.

The WTRU behavior may be based on detecting/receiving a first/second indication. A WTRU may be configured to perform cell (re-)selection based on detecting/receiving a first/second indication. The WTRU may be configured to perform cell (re-)selection after/within a threshold duration T after receiving the first/second indication from the network, as described herein.

A WTRU may be configured to exclude a set of cells as (re-)selection candidates, wherein the WTRU determines the set of cells as determined by the scope of the network energy saving mechanism based on detecting/receiving a first/second indication from the network. The WTRU may be configured to exclude the set of such cells as re-selection candidates for a configured duration T, which can be configured to the WTRU. The configured duration T can be 300 seconds, 200 seconds, 100 seconds etc. Other values can be (pre-) configured or specified to be used for excluding the cells as (re-)selection candidates.

In examples, the WTRU may be configured to perform (re-)selection over a specific type of cells (e.g., NTN cells, or TN cells), or beams from a specific type of NTN satellite (e.g., LEO/MEO/GEO) or from a different version of NTN entity (e.g., UAV or HAPS etc.). The WTRU may be configured to perform (re-) selection over a type of cells/beams/NTN-entities based on the cell, wherein WTRU was initially camped, based on the type of the cell through which the WTRU detects/receives the first/second indication, or based on information received in the first/second indication.

In examples, a WTRU may determine to camp over a specific type of cells (e.g., TN or NTN cells) or specific type of orbits among NTN cells (e.g., LEO/MEO/GEO) based on detecting/receiving a first/second indication. The WTRU may be configured to camp over a specific type/orbit of cells/beams, or cells/beams under specific type of energy saving mechanism (e.g., applying a specific energy saving mechanism or no energy saving technique etc.) based on receiving a second indication where the second indication is received, as described herein.

The WTRU may provide an indication after performing cell re-selection. A WTRU may be configured to provide an indication to the network after performing cell (re-)selection based on detecting/receiving a first/second indication from the network. In examples, the WTRU may be configured to provide the indication in the form of RAN notification area (RNA) update or tracking area code (TAC) update or change of PLMN, or by the transmission of a specific signal/information to the network. The WTRU may be configured to transmit the indication based on one or more of the following: performing cell (re-)selection to a cell that is not part of WTRU's current RNA/TAC/PLMN; performing cell (re-)selection to a cell that is part of WTRU's current RNA/TAC/PLMN; performing cell (re-)selection to a type of cell (e.g., TN or NTN), a specific orbit type (e.g., LEO/MEO/GEO) etc.; or performing cell (re-)selection to a cell/beam using a type of energy saving technique, or no energy saving technique.

The WTRU may determine a cell becoming unavailable in the future. A WTRU may determine a cell or beam not being available in the future. The WTRU may determine a cell/beam not being available in the future based on the configuration where the configuration is described herein.

In examples, the WTRU may determine a cell becoming unavailable based on the configuration of remaining service time indication received for an NTN cell. In examples, the WTRU may determine cell becoming unavailable based on an indication of beam power sharing detected/received from a cell (e.g., an NTN cell). In examples, the WTRU may receive the indication of cells (e.g., TN cells or NTN cells), coverage indication of cells (e.g., location of cells in appropriate format etc.) and UL-WUS configurations for the cells as part of the indication. In examples, the WTRU may have received prior configuration for a set of parameters, and the indication may imply selecting a suitable subset (e.g., one best) configuration from the configured set of configurations. The WTRU may be provided with the coverage indication for the indicated cells.

In examples, the WTRU may be configured to determine a cell not being available based on explicit information, e.g., paging, SIB indication or another explicit indication method. In examples, the WTRU may be configured to determine cell not being available based on detecting a change in one of the DL signals or based on detecting a change in the network energy saving state.

The WTRU determination may be based on the detection from signals, or an indication received from the cell (TN cell or an NTN cell) it is camped on or it could be from a different cell that WTRU is configured to receive/detect the indication from, e.g., a macro cell or a stable cell that WTRU is configured to detect the indication from. The WTRU may receive the indication in any of the RRC states, e.g., RRC Idle, RRC Inactive or RRC connected state. The WTRU may be configured to detect/receive the indication from a cell (e.g., an NTN cell). In some examples, the WTRU may receive the indication from a TN cell. The WTRU may receive the indication from a cell/beam of a specific orbit (e.g., LEO/MEO/GEO etc.). The WTRU may be configured to receive the indication from a cell/beam of the same or different orbit cell/beam compared to where it is camped on.

A WTRU may detect a cell becoming unavailable (e.g., unavailable soon) (e.g., radio conditions degrading). The WTRU may determine a cell or beam not being available. The WTRU may determine a cell/beam not being available based on one or more of the following: detecting a change in the energy saving state of the cell/beam; receiving an indication of the change in the energy saving state of the cell/beam; detecting a change in the transmission of common signals/channels from the cell/beam; based on the measurements made over the signals/channels from the cell/beam, e.g., based on the measurements falling below a given threshold, e.g., RSRP of the SSB falls below a configured threshold; based on RACH procedure failure on the cell for a configured number of times; or based on WTRU mobility knowledge e.g., WTRU going indoors from outdoors, or WTRU moving with velocity larger than a configured threshold.

A WTRU may wake up a cell. A WTRU may request a cell to change/update its energy saving state. The WTRU may request a cell to change its energy saving state by transmitting an indication, e.g., an uplink wake-up signal (UL-WUS) indication in the UL direction. The request to change the energy saving state may be a request to change the state to a specific state, e.g., moving from common channel transmission to normal state with transmission of common and dedicated channels, moving from SSB state to transmission of SIB1 and other SIBs, moving from a deep sleep state to micro sleep state, or moving from deep sleep to complete wake up. In examples, the WTRU request may be for a TN cell to wake up completely for normal operation from its deep sleep state or from any energy saving state. The WTRU may transmit the UL-WUS indication based on the received configuration, as described herein. The WTRU transmitted UL indication may include one or more of the following: a RACH transmission, wherein the RACH resource may be a dedicated resource for changing the energy saving state or the common RACH resource; an UL-WUS indication which can be a signal transmission different from the RACH or the same signal as RACH (e.g., the resource configured for UL-WUS transmission may be the same or different from the RACH configuration); an SRS transmission over the configured resource; or the transmission of any general/specific RS configured to be used as an indication for change of energy saving state.

The WTRU may transmit the UL-WUS indication to a cell (e.g., a sleeping TN cell) according to the available configuration to transmit UL-WUS indication. The WTRU may be configured to transmit the UL-WUS indication based on one or more of the following conditions being fulfilled. A condition may include a time validity for the transmission of UL-WUS indication, e.g., the WTRU may transmit a wake up indication (e.g., UL-WUS signal) if the configurations are valid, e.g., a validity timer associated to the configuration has not expired yet. A condition may include the WTRU being in the coverage of the target cell. The WTRU may be provided the coverage of the cell, e.g., through a reference location and a radius, and WTRU determination of itself being in the coverage by determining its location and the distance of its own location and the reference location being smaller than the radius. A condition may include a location validity for the UL-WUS indication transmission. This may, for example, be based on the WTRU having been configured with UL-WUS configuration with a location validity criterion (e.g. WTRU distance from a Ref Location). A condition may include a number of re-transmissions according to the UL-WUS configuration

The WTRU may be configured to transmit the UL-WUS signal to the cell that the WTRU determines to wake up. In examples, the WTRU may be configured with a macro or stable cell in association with a target cell. The WTRU, based on determining to wake up the target cell may transmit the UL-WUS to the macro or stable cell associated with the target cell.

A WTRU may detect the wake up of a cell & performing cell re-selection. The WTRU may detect the change in the energy saving state of a cell (e.g., a TN cell or an NTN cell). The change in the energy saving state of the cell may be from an (e.g., one) energy saving state to another energy saving state. In examples, the change may be related to complete wake up of the cell from energy saving states. The WTRU may be configured to detect the change in the energy saving state of a cell based on the transmission of its indication in the UL direction, e.g., subsequent to its UL-WUS transmission.

Based on detecting a change, e.g., a wake up, in the energy saving state of the cell subsequent to the WTRU transmitting a UL-WUS transmission (e.g., a UL-WUS transmission), the WTRU may perform cell (re-)selection. The WTRU may be configured to prioritize the cell for which the WTRU transmitted UL-WUS, as a cell (re-)selection candidate. The WTRU may be configured to prioritize cells based on WTRU's target cell for which WTRU transmitted UL-WUS. The prioritization may include the WTRU applying offsets/thresholds to the cell measurements of the cells. The offsets and the thresholds may be known to the WTRU through (pre-) configuration, specification, or by indication from the network.

A WTRU may wake up a cell (e.g., a TN cell) based on detecting that the NTN cell the WTRU is camped on is not suitable. In some examples, the WTRU may have performed re-selection to NTN cell based on receiving shut down trigger from a cell (e.g., a TN cell). The WTRU may detect that the NTN cell is not suitable based on the signals received from the NTN cell. The WTRU may detect that the NTN cell is not suitable based on signal measurements, detecting a change in one of the physical properties of the signals or missing signals from the NTN cell.

The WTRU may wake up a TN cell based on losing an NTN cell and after re-selecting to the NTN cell. A WTRU camped over a TN cell may detect a first indication to validate if an NTN cell is suitable. The WTRU may make measurements over the indicated NTN cell and evaluate the measurements if the measurements fulfill the configured conditions. The WTRU may detect a second indication, wherein a (e.g., the TN) cell indicates its shut-down. Upon detecting the second indication, the WTRU may exclude TN cell(s) from re-selection candidates and re-select to an NTN cell. Upon an NTN cell becoming not available/suitable (e.g., due to NTN power sharing/link conditions), the WTRU may wake up the sleeping TN cell to camp on.

A WTRU may be camped on a TN cell and configured with one or more of the following: a first message configuration to validate that at least one of the NTN cell is suitable; a second message configuration indicating TN cell shutting down; an UL-WUS configuration to wake-up TN cell with validity conditions; or a configuration for NTN Cells to perform measurements in IDLE/INACTIVE mode. The WTRU may receive characteristics of the NTN cells (e.g., LEO, MEO, GEO), power sharing status and SIBs (e.g., SIB19). Validity conditions and reselection/re-selection conditions may be used interchangeably as described herein.

The WTRU may detect/receive a first message indicating to validate that at least one of the NTN cells is suitable where the first message could be an explicit indication (paging message, or SI update message or DL-WUS, freq priority update indication SIB) or an implicit indication (e.g., reduced/modified/SIB1-less SSB etc).

In some examples, the (e.g., power saving) WTRU may select NTN cells to perform measurements based on one of the following: NTN Beam power sharing status (e.g. if provided by TN cell); cells of a specific orbit (e.g., WTRU may select GEO cells to avoid frequent re-selections and SI maintenance); WTRU power status (e.g., if WTRU is a plugged device, CPE); or a WTRU local mobility estimate (e.g. a fixed or static vs WTRU in mobility).

The WTRU may determine the selected/indicated NTN Cells being suitable based on one or more of the following conditions: NTN Beam power sharing status (e.g., received from TN/NTN or detected from signals) (e.g., inactive periodicity less than T, active beam power reduction less than P); cells of a specific orbit (e.g., WTRU may select GEO cells to avoid frequent re-selections and SI maintenance); or RSRP of the RS (e.g., SSB) is better than a threshold (e.g., with/without compensated measurements if NTN cells under Beam power sharing). In examples, if no suitable cell is found, actions described herein may be performed.

The WTRU may detect/receive a second message from TN cell indicating a shut-down of TN cells (e.g., single TN cell, RNA/TAC cells, etc) after a threshold duration where the second message could be an explicit indication (paging or SI update message or DL-WUS, freq priority update indication SIB) or an implicit indication (e.g., reduced/modified/SIB1-less SSB etc). The type of second message may be based on the type of the first message.

The WTRU may exclude the TN cell. The WTRU may wake up a TN cell based on losing NTN cell after re-selecting to NTN cell. The WTRU may camp over the NTN Cell (e.g., as a by-product of a previous exclusion of TN cells).

The WTRU may detect an NTN cell becoming unavailable in the future due to NTN power sharing (e.g., a DTx period larger than T, or power-sharing larger than P) or T_Service (e.g., a WTRU losing service coverage). The NTN cell may provide service/power indication and (e.g., broadcast) assistance to the WTRU, e.g. UL-WUS config for a TN Cell (e.g., a third TN Cell).

The WTRU may transmit a UL-WUS to a sleeping TN cell (e.g., the third TN cell) according to the received WUS configuration if one or more of the following conditions are satisfied: a time validity for UL-WUS configurations are valid (e.g. config timer has not expired); a location validity for UL-WUS configuration is valid (e.g. WTRU distance from a ref location); or a number of re-transmissions according to the UL-WUS configuration.

The WTRU may detect SSB/SIBs from the TN cell and perform re-selection to the TN cell. A higher network energy saving for TN and NTN Cells may be associated with enabling the operation for WTRUs in idle/inactive mode.

A WTRU may wake up a TN cell based on losing an NTN cell after re-selecting to an NTN cell. As described herein, a WTRU camped over a TN cell may detect a first indication to validate if an NTN cell is suitable. The WTRU may make measurements over the indicated NTN cell and evaluate the measurements if they fulfill the configured conditions. The WTRU may detect a second indication whereby a TN cell indicates its shut-down. Upon detecting the second indication, the WTRU may exclude TN cell(s) from re-selection candidates and re-select to an NTN cell. Upon an NTN cell becoming not available/suitable (e.g., due to NTN power sharing/link conditions), the WTRU may wake up the sleeping TN cell to camp on.

A WTRU may be camped on a TN cell and configured with one or more of the following: a configuration for NTN cells to perform measurements in IDLE/INACTIVE mode. The WTRU may receive characteristics of the NTN cells (e.g., LEO, MEO, GEO), power sharing status and SIBs (e.g., SIB19); a first message configuration to validate that at least one of the NTN cells is suitable; a second message configuration indicating TN cell shutting down; or an UL-WUS configuration to wake-up TN cell with validity conditions

The WTRU may detect/receive a first message indicating to validate that at least one of the NTN cells is suitable where the first message may be an explicit indication (e.g., paging message, or SI update message or DL-WUS, freq priority update indication SIB) or an IMPLICIT indication (e.g., reduced/modified/SIB1-less SSB etc.).

The (e.g., power saving) WTRU may select NTN cells to perform measurements based on one of the following: NTN Beam power sharing status (e.g., if provided by TN cell); cells of an orbit (e.g., WTRU may select GEO cells to avoid frequent re-selections and SI maintenance); WTRU power status (e.g., if WTRU is a plugged device, CPE); or WTRU local mobility estimate (e.g., fixed or static vs WTRU in mobility).

The WTRU may determine the selected/indicated NTN cells being suitable based on the following conditions: NTN Beam power sharing status [received from TN/NTN or detected from signals] [Inactive Periodicity less than T, active beam power reduction less than P]; or cells of a specific orbit (e.g., WTRU may select GEO cells to avoid frequent re-selections and SI maintenance); or RSRP of the RS (e.g., SSB) is better than a threshold (with/without compensated measurements if NTN cells under Beam power sharing). In examples, if no suitable cell is found, actions described herein may be performed.

The WTRU may detect/receive a second message from a TN cell indicating a shut-down of TN cells (e.g., single TN cell, RNA/TAC cells, etc.) after a threshold duration, wherein the second message may be an explicit indication (e.g., paging or SI update message or DL-WUS, freq priority update indication SIB) or an implicit indication (e.g., reduced/modified/SIB1-less SSB etc.). The type of second message may be based on the type of the first message.

The WTRU may exclude the TN cells (e.g., camped cell or the intra-freq or same RNA/TAC, or all TN) as candidate(s) for cell selection/reselection for a configured duration T (e.g., 300 seconds). The WTRU may camp over the NTN cell (e.g., as a by-product of previous exclusion step of TN cells).

The WTRU may detect an NTN cell becoming unavailable in the future due to NTN Power Sharing (e.g., DTx period larger than T, power-sharing larger than P) or T_Service (e.g., WTRU losing service coverage). The NTN cell may provide service/power indication and (e.g., broadcast) assistance to the WTRU, e.g., UL-WUS config for a TN cell (e.g., a third TN cell).

The WTRU may transmit a UL-WUS to a sleeping TN cell (e.g., the third TN cell) according to the received WUS configuration if one or more of the following conditions are satisfied: a time validity for UL-WUS configurations are valid (e.g., config timer has not expired); a location validity for UL-WUS configuration is valid (e.g. WTRU distance from a Ref Location); or a number of re-transmissions according to the UL-WUS config

The WTRU may detect SSB/SIBs from the TN cell and perform re-selection to the TN cell. A higher network energy saving for TN and NTN cells may be associated with enabling the operation for WTRUs in idle/inactive mode. The WTRU may re-select from TN to NTN cell based on a TN sleep indication. A WTRU may re-select from TN to NTN cell based on a TN sleep indication.

A WTRU camped over a TN cell may detect/receive a first message to validate if an NTN cell is suitable. The WTRU may make measurements over the indicated NTN cell and evaluate the measurements if they fulfill the configured conditions. The WTRU may receive a second message, wherein a TN cell may indicate its shut-down. The WTRU may exclude TN cell(s) from re-selection candidates and re-select to NTN cell.

A WTRU may be camped on a TN cell and may be configured with one or more of the following. The WTRU may be configured with a configuration for NTN cells to perform measurements in IDLE/INACTIVE mode. The WTRU may receive characteristics of the NTN cells (e.g., LEO, MEO, GEO), power sharing status, and SIBs (e.g., SIB19). The WTRU may be configured with a first message configuration to validate that at least one of the NTN cells is suitable. The WTRU may be configured with a second message configuration indicating TN cell shutting down.

The WTRU may detect/receive a first message indicating to validate that at least one of the NTN cells is suitable, wherein the first message may be an explicit indication (e.g., paging message, or SI update message or DL-WUS, freq priority update indication SIB) or an implicit indication (e.g., reduced/modified/SIB1-less SSB etc.).

The (e.g., power saving) WTRU may select NTN cells to perform measurements based on one of the following: an NTN Beam power sharing status (e.g., if provided by TN cell); cells of a specific orbit (e.g., WTRU may select GEO cells to avoid frequent re-selections and SI maintenance); a WTRU power status (e.g., if WTRU is a plugged device, CPE); or a WTRU local mobility estimate (e.g., fixed or static vs WTRU in mobility).

The WTRU may determine the selected/indicated NTN cells being suitable based on one or more of the following conditions: an NTN Beam power sharing status (e.g., received from TN/NTN or detected from signal) (e.g., inactive periodicity less than T, active beam power reduction less than P); cells of a specific orbit (e.g., WTRU may select GEO cells to avoid frequent re-selections and SI maintenance); an RSRP of the RS (e.g., SSB) is better than a threshold (with/without compensated measurements if NTN cells under Beam power sharing). In examples, if no suitable cell is found, actions described herein may be performed.

The WTRU may detect/receive a second message from TN cell indicating a shut-down of TN cells (e.g., single TN cell, RNA/TAC cells, etc.) after a threshold duration, wherein the second message may be an explicit indication (e.g., paging or SI update message or DL-WUS, freq priority update indication SIB) or an implicit indication (e.g., reduced/modified/SIB1-less SSB etc.). The type of second message may be based on the type of the first message.

The WTRU may exclude the TN cells (e.g., camped cell or the intra-freq or same RNA/TAC, or all TN) as candidate(s) for cell selection/reselection for a configured duration T (e.g., 300 seconds). The WTRU may camp over the NTN cell (e.g., as by-product of an exclusion of TN cells). A higher network energy saving for TN and NTN cells may be associated with enabling the smooth operation for WTRUs in idle/inactive mode.

The WTRU may fallback based on not finding a suitable NTN Cell. A WTRU camped over a TN cell may receive a first message to validate if an indicated NTN cell is suitable. The WTRU may make measurements over the indicated NTN cell. Upon evaluation, the measurements may not fulfill the configured conditions. The WTRU may provide a stay awake indication to the TN cell indicating that the NTN cell is not suitable. The TN cell may not shut down, and the WTRU may stay camped over the TN cell.

A WTRU may be camped on a TN cell and configured with one or more of the following: a configuration for NTN Cells to perform measurements in IDLE/INACTIVE mode. The WTRU may receive characteristics of the NTN cells (e.g., LEO, MEO, GEO), power sharing status and SIBs (e.g., SIB19);

The WTRU may be configured with one or more of a first message configuration to validate that at least one of the NTN cell is suitable; a second message configuration indicating TN cell shutting down; a UL-WUS configuration to wake-up TN cell with validity conditions; or a stay awake signal transmission configuration over the TN cell if the NTN cell is not suitable according to the configured conditions.

The WTRU may detect/receive a first message indicating to validate that at least one of the NTN Cells is suitable where the first message may be an explicit indication (e.g., paging message, or SI update message or DL-WUS, freq priority update indication SIB) or an implicit indication (e.g., reduced/modified/SIB1-less SSB etc).

The (e.g., power saving) WTRU may select NTN cells to perform measurements based on one of the following: an NTN Beam power sharing status (e.g. if provided by TN cell); cells of a specific orbit (e.g., WTRU may select GEO cells to avoid frequent re-selections and SI maintenance); a WTRU power status (e.g., if WTRU is a plugged device, CPE); or a WTRU local mobility estimate (e.g. fixed or static vs WTRU in mobility). In examples, the WTRU may not select a cell.

The WTRU may determine the selected/indicated NTN cells being suitable based on the following conditions: an NTN Beam power sharing status (e.g., received from TN/NTN or detected from signals) (e.g., inactive periodicity less than T, active beam power reduction less than P); cells of a specific orbit (e.g., WTRU may select GEO cells to avoid frequent re-selections and SI maintenance); an RSRP of the RS (e.g., SSB) is better than a threshold (e.g., with/without compensated measurements if NTN cells under beam power sharing).

The WTRU may transmit the stay awake indication to the TN cell based on determining that there is no suitable NTN cell, wherein the stay awake indication may be based on one or more of the following: transmitted over a common/shared resource (e.g., cell specific resource); or a RACH/UL-WUS/SRS transmission.

The WTRU may stay camped over the TN Cell. The WTRU may stay in-coverage by timely informing its TN cell not to shut down as the WTRU is not under suitable NTN coverage.

The WTRU may wake up a sleeping TN Cell based on an NTN Cell becoming not suitable/available in the future. In examples, a WTRU may be camped over an NTN cell. Upon the NTN cell becoming not available/suitable (e.g., NTN power sharing/satellite movement), the WTRU may wake up a neighboring TN cell from its energy saving sleep mode to camp on it.

A WTRU may be camped on an NTN cell and configured with one or more of the following: a configuration for (sleeping) TN Cells where the configuration may provide any of the following: a timing, frequency, a cell identity in suitable format; energy saving state of the cell (e.g., cell DTx with associated parameters, an SSB only cell with on-demand SIB1 configuration, a modified SSB transmitting cell, a cell in deep sleep with no transmission at all); an UL-WUS configuration to wake-up TN cell with validity conditions; or a coverage indication for each cell where the coverage indication can be provided through different manners. In examples, the coverage indication may be a reference location with a radius indication. The reference location may be the (virtual) cell center of the target cell, or it may be the TRP location, or it may be a suitable boundary point b/w NTN and TN cell boundary. In examples, the coverage indication may be with respect to a different shape, a rectangle, a polygon, etc.

The WTRU may determine that an NTN cell is becoming unavailable in the future due to NTN Power Sharing (e.g., DTx period larger than T, power-sharing larger than P) or T_Service (e.g., WTRU losing service coverage). The WTRU determination of the NTN cell becoming unavailable may be based on one or more of the following: an explicit indication received from the NTN cell (e.g. broadcast of information, system information update in any SIB, e.g. SIB1, SIB19 etc., paging, etc.); or an implicit indication through detecting change in one of the broadcast signals, e.g., change of SSB periodicity, change of SSB structure (to slim SSB e.g.,), change in SIB transmission (e.g., missing SIB1).

The WTRU may receive assistance information from the NTN cell related to the neighboring TN cells. This information may be the same/similar to as provided by NTN cell, as described herein. The information may complement or override the configuration stored at the WTRU

The WTRU may determine the TN cell configurations based on received coverage indications and its own location. For example, the WTRU may select the TN cells based on determination that its determined location lies inside the indicated coverage of that cell. In examples, the WTRU may select the cell whose reference point is closest to its determined location. The WTRU may select one or more cells based on indicated coverage and its own location determination.

The WTRU may select one or more cells based on detected SSBs (or modified SSBs). The WTRU may detect SSBs based on received configurations for TN cells indicating time, frequency and other parameters for the TN cells.

The WTRU may transmit a UL-WUS to the selected (e.g., sleeping) TN cell according to the received WUS configuration if any of the following conditions are satisfied: time validity for UL-WUS configurations are valid (e.g. config timer has not expired); location validity for the cell coverage; location validity for UL-WUS configuration is valid (e.g. WTRU distance from a Ref Location); number of re-transmissions according to the UL-WUS config; SSBs (legacy/slim/modified) detected for the cell are received with sufficient received power levels (e.g., RSPR higher than a configured threshold)

The WTRU may detect SSBs (and SIBs, e.g., SIB1) from the TN cell within a threshold duration after its transmission of UL-WUS signal. The WTRU may perform re-selection to the TN cell if the cell re-selection criteria is satisfied (e.g., the TN cell is a suitable cell for camping purpose). Higher network energy saving for TN and NTN Cells may be associated with enabling operation for WTRUs in idle/inactive mode.

The WTRU may wake up a sleeping TN Cell based on losing an NTN Cell. A WTRU may be camped over an NTN cell. Upon NTN cell becoming not suitable (e.g., RSRP going below a threshold), the WTRU may wake up a neighboring TN cell from its energy saving sleep mode to camp on it. A WTRU may be camped on an NTN cell and configured with one or more of the following: a configuration for (e.g., sleeping) TN Cells where the configuration may provide one or more of the following: timing, frequency, cell identity in suitable format; energy saving state of the cell (e.g., Cell DTx with associated parameters, SSB only cell with on-demand SIB1 configuration, modified SSB transmitting cell, cell in deep sleep with no transmission at all); a UL-WUS configuration to wake-up TN cell with validity conditions; or a coverage indication for a cell where the coverage indication may be provided through different manners. In examples, the coverage indication may be a reference location with a radius indication. The reference location may be the (virtual) cell center of the target cell, or it may be the TRP location, or it may be a suitable boundary point between an NTN and TN cell boundary. In examples, the coverage indication may be with respect to a different shape, a rectangle, a polygon etc.

The WTRU may determine an NTN cell becoming not suitable (e.g., RSRP of the SSBs from NTN cell falls below a configured threshold, RACH failure on NTN cell). The WTRU determination of the NTN cell becoming unavailable may be based on one or more of the following: RSRP of the SSBs from NTN cell falls below a configured threshold; or RACH failure on NTN cell.

The WTRU may determine the TN cell configurations based on received coverage indications and its own location. For example, the WTRU may select the TN cells based on determination that its determined location lies inside the indicated coverage of that cell. In examples, the WTRU may select the cell whose reference point is closest to its determined location. The WTRU may select one or more cells based on indicated coverage and its own location determination.

The WTRU may select one or more cells based on detected SSBs (or modified SSBs). The WTRU may detect SSBs based on received configurations for TN cells indicating time, frequency and other parameters for the TN cells.

The WTRU may transmit a UL-WUS to the selected (e.g., sleeping) TN cell according to the received WUS configuration if one or more of the following conditions are satisfied: time validity for UL-WUS configurations are valid (e.g. config timer has not expired); location validity for the cell coverage; location validity for UL-WUS configuration is valid (e.g. WTRU distance from a Ref Location); number of re-transmissions according to the UL-WUS config; or SSBs (legacy/slim/modified) detected for the cell are received with sufficient received power levels (e.g., RSPR higher than a configured threshold). The WTRU may detects SSBs (and SIBs, e.g., SIB1) from the TN cell within a threshold duration after its transmission of UL-WUS signal. The WTRU may perform re-selection to the TN cell if the cell re-selection criteria is satisfied (e.g., the TN cell is a suitable cell for camping purpose). A higher network energy saving for TN and NTN Cells may be associated with enabling the smooth operation for WTRUs in idle/inactive mode.

Systems, methods, and instrumentalities are configured for non-terrestrial network-terrestrial network (NTN-TN) IDLE MODE MOBILITY FOR network (NW) ENERGY SAVINGS. A wireless transmit receive unit (WTRU) may receive configuration information associated with a first candidate non-terrestrial network (NTN) cell and a second candidate NTN cell. The configuration information may indicate a first candidate NTN cell and a second candidate NTN cell. The first candidate NTN cell may be associated with a first orbit type and a first NTN power sharing status. The second candidate NTN cell may be associated with a second cell orbit type and a second NTN power sharing status. The WTRU may receive a first message that indicates to perform an NTN cell suitability determination associated with the first candidate NTN cell and the second candidate NTN cell. The WTRU may perform a measurement associated with the first candidate NTN cell and a measurement associated with the second candidate NTN cell. The WTRU may determine that the first candidate NTN cell satisfies suitability conditions based on the first NTN power sharing status, the first orbit type, and the measurement associated with the first candidate NTN cell. Satisfaction of the suitability conditions may include satisfaction of one or more of an NTN power sharing status condition, an orbit condition, and a measurement threshold condition. The WTRU may receive a second message. The second message may be received from a terrestrial network (TN) cell, and the second message may indicate a shutdown associated with one or more TN cells. The WTRU may exclude the one or more TN cells associated with the shutdown as re-selection candidates based on the received second message.

The WTRU may determine that the first candidate NTN cell will become unavailable based on one or more of satisfying an NTN power sharing condition, satisfying a service coverage condition, or an indication from the first NTN cell. The WTRU may receive an indication of a wake up signal configuration, and the wake up signal configuration may indicate one or more TN cells associated with the wake up signal configuration. The wake up signal configuration may indicate configuration validity conditions based on a timer or a WTRU location. The WTRU may transmit a wake up signal to a TN cell from the one or more TN cells for which the configuration validity conditions are satisfied. The wake up signal may be configured according to the wake up signal configuration. The WTRU may perform reselection on the TN cell from the one or more TN cells for which the configuration validity conditions are satisfied.

The validity conditions may include one or more of a time validity associated with the wake up signal configuration, a location validity associated with the wake up signal configuration, or a location validity associated with cell coverage. The NTN power sharing condition may include one or more of a discontinuous transmission period that exceeds a time threshold or a power sharing status that exceeds a power threshold. The WTRU may receive configuration information associated with one or more TN candidate cells. The WTRU may perform reselection, and the reselection may be performed on the TN candidate cells and the first candidate NTN cell. The WTRU may determine to perform the measurement associated with the first candidate NTN cell based on one or more of: the first NTN power sharing status, the first orbit type, a power status of the WTRU, or a mobility estimate associated with the WTRU

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit receive unit (WTRU) comprising:
a processor configured to:
receive configuration information associated with non-terrestrial network (NTN) cells, wherein the configuration information indicates a first candidate NTN cell and a second candidate NTN cell, wherein the first candidate NTN cell is associated with a first orbit type and a first NTN power sharing status, and wherein the second candidate NTN cell is associated with a second cell orbit type and a second NTN power sharing status;
receive a first message that indicates to perform an NTN cell suitability determination associated with the first candidate NTN cell and the second candidate NTN cell;
perform a measurement associated with the first candidate NTN cell and a measurement associated with the second candidate NTN cell;
determine that the first candidate NTN cell satisfies suitability conditions based on the first NTN power sharing status, the first orbit type, and the measurement associated with the first candidate NTN cell, wherein satisfaction of the suitability conditions comprises satisfaction of: an NTN power sharing status condition, an orbit condition, and a measurement threshold condition;
receive a second message, wherein the second message is received from a terrestrial network (TN) cell, and wherein the second message indicates a shutdown associated with a first one or more TN cells; and
exclude the first one or more TN cells associated with the shutdown as re-selection candidates based on the received second message.

2. The WTRU of claim 1, the processor further configured to:
determine that the first candidate NTN cell will become unavailable based on one or more of satisfying an NTN power sharing condition, satisfying a service coverage condition, or an indication from the first candidate NTN cell;
receive an indication of a wake up signal configuration, wherein the wake up signal configuration indicates a second one or more TN cells, and wherein the wake up signal configuration indicates cell re-selection conditions based on a timer or a WTRU location;
transmit a wake up signal to a TN cell from the second one or more TN cells for which the cell re-selection conditions are satisfied, wherein the wake up signal is configured according to the wake up signal configuration;
detect a wake up of a TN cell from the second one or more TN cells based on a signal received from the TN cell from the second one or more TN cells; and
perform reselection to the TN cell from the second one or more TN cells for which the cell re-selection conditions are satisfied.

3. The WTRU of claim 2, wherein the cell re-selection conditions comprise one or more of a time validity associated with the wake up signal configuration, a location validity associated with the wake up signal configuration, a location validity associated with cell coverage, or a location validity associated with a location of the WTRU.

4. The WTRU of claim 2, wherein the NTN power sharing condition comprises one or more of a discontinuous transmission period that exceeds a time threshold, a ratio of inactive duration to active duration exceeding a ratio threshold, or a power sharing of beams with a power reduction, wherein the power reduction exceeds a power threshold.

5. The WTRU of claim 1, wherein the processor is further configured to:
perform cell re-selection to the first candidate NTN cell.

6. The WTRU of claim 1, wherein the processor is further configured to:
receive configuration information associated with a second one or more TN cells;
evaluate the second one or more TN cells and the first candidate NTN cell for reselection; and
perform reselection on the first candidate NTN cell or one of the second one or more TN cells.

7. The WTRU of claim 1, wherein the processor is further configured to:
determine to perform the measurement associated with the first candidate NTN cell based on one or more of: the first NTN power sharing status, the first orbit type, a power status of the WTRU, or a mobility estimate associated with the WTRU.

8. A method for a wireless transmit receive unit (WTRU), the method comprising:
receiving configuration information associated with non-terrestrial network (NTN) cells, wherein the configuration information indicates a first candidate NTN cell and a second candidate NTN cell, wherein the first candidate NTN cell is associated with a first orbit type and a first NTN power sharing status, and wherein the second candidate NTN cell is associated with a second cell orbit type and a second NTN power sharing status;
receiving a first message that indicates to perform an NTN cell suitability determination associated with the first candidate NTN cell and the second candidate NTN cell;
performing a measurement associated with the first candidate NTN cell and a measurement associated with the second candidate NTN cell;
determining that the first candidate NTN cell satisfies suitability conditions based on the first NTN power sharing status, the first orbit type, and the measurement associated with the first candidate NTN cell, wherein satisfaction of the suitability conditions comprises satisfaction of: an NTN power sharing status condition, an orbit condition, and a measurement threshold condition;
receiving a second message, wherein the second message is received from a terrestrial network (TN) cell, and wherein the second message indicates a shutdown associated with a first one or more TN cells; and
excluding the first one or more TN cells associated with the shutdown as re-selection candidates based on the received second message.

9. The method of claim 8, the method further comprising:
determining that the first candidate NTN cell will become unavailable based on one or more of satisfying an NTN power sharing condition, satisfying a service coverage condition, or an indication from the first candidate NTN cell;
receiving an indication of a wake up signal configuration, wherein the wake up signal configuration indicates a second one or more TN cells, and wherein the wake up signal configuration indicates cell re-selection conditions based on a timer or a WTRU location;
transmitting a wake up signal to a TN cell from the second one or more TN cells for which the cell re-selection conditions are satisfied, wherein the wake up signal is configured according to the wake up signal configuration;
detecting a wake up of a TN cell from the second one or more TN cells based on a signal received from the TN cell from the second one or more TN cells; and
performing reselection to the TN cell from the second one or more TN cells for which the cell re-selection conditions are satisfied.

10. The method of claim 9, wherein the cell re-selection conditions comprise one or more of a time validity associated with the wake up signal configuration, a location validity associated with the wake up signal configuration, a location validity associated with cell coverage, or a location validity associated with a location of the WTRU.

11. The method of claim 9, wherein the NTN power sharing condition comprises one or more of a discontinuous transmission period that exceeds a time threshold, a ratio of inactive duration to active duration exceeding a ratio threshold, or a power sharing of beams with a power reduction, wherein the power reduction exceeds a power threshold.

12. The method of claim 8, wherein the method further comprises:
performing cell re-selection to the first candidate NTN cell.

13. The method of claim 8, wherein the method further comprises:
receiving configuration information associated with a second one or more TN cells;
evaluating the second one or more TN cells and the first candidate NTN cell for reselection; and
performing reselection on the first candidate NTN cell or one of the second one or more TN cells.

14. The method of claim 8, wherein the method further comprises:
determining to perform the measurement associated with the first candidate NTN cell based on one or more of: the first NTN power sharing status, the first orbit type, a power status of the WTRU, or a mobility estimate associated with the WTRU.
